(19) United States
(12) Patent Application Publication
(10) Pub. No.: US 2010/0049704 A1
(43) Pub. Date: Feb. 25, 2010

(54) Map information processing apparatus, navigation system, and map information processing method

(76) Inventor: Kazutoshi Sumiya, Himeji-shi (JP)

Correspondence Address: DAY PITNEY LLP, 7 TIMES SQUARE, NEW YORK, NY, 10036-7311, US

(21) Appl. No.: 12/321,344

(22) Filed: Jan. 16, 2009

(30) Foreign Application Priority Data
Aug. 25, 2008 (JP) JP 2008-214895

(51) Int. Cl. G06F 17/30; G06F 7/10; G09G 5/00; G01C 21/00

(52) U.S. Cl. 707/5; 707/104.1; 345/660; 701/300; 701/200; 707/E17.018; 707/E17.108; 707/3

(57) ABSTRACT

A map information processing apparatus includes: a map information storage portion in which multiple pieces of map information can be stored; an accepting portion that accepts a map output instruction and a map browse operation sequence; a map output portion that reads the map information and outputs a map in a case where the map output instruction is accepted; an operation information sequence acquiring portion that acquires an operation information sequence, which is information of at least one operation corresponding to the accepted map browse operation sequence; a display attribute determining portion that selects at least one object and determines a display attribute of the at least one object in a case where the operation information sequence matches an object selecting condition, which is a predetermined condition for selecting an object; and a map output changing portion that acquires map information corresponding to the map browse operation, and outputs map information having the at least one object according to the display attribute of the at least one object determined by the display attribute determining portion.

### BACKGROUND OF THE INVENTION

1. Field of the Invention

The present invention relates to map information processing apparatuses and the like for changing a display attribute of an object (a geographical name, an image, etc.) on a map according to a map browse operation sequence, which is a group of one or at least two map browse operations.

2. Description of Related Art

Conventionally, there has been a map information processing apparatus that can automatically provide appropriate information according to a map browse operation (see JP 2008-39879A (p. 1, FIG. 1, etc.), for example). This map information processing apparatus includes: a map information storage portion in which map information, which is information of a map, can be stored; an accepting portion that accepts a map browse operation, which is an operation to browse the map; an operation information sequence acquiring portion that acquires operation information, which is information of an operation corresponding to the map browse operation; a keyword acquiring portion that acquires at least one keyword from the map information using the operation information; a retrieving portion that retrieves information using the at least one keyword; and an information output portion that outputs the information retrieved by the retrieving portion.

However, in the conventional map information processing apparatus, the display status of an object on a map is not changed according to one or more map browse operations. As a result, an appropriate map according to the map operation history of a user is not displayed.

Furthermore, in the conventional map information processing apparatus, appropriate information cannot be presented also considering user operations (e.g., input of keywords, browse of web pages, etc.) leading to display of a map.

### SUMMARY OF THE INVENTION

A first aspect of the present invention is directed to a map information processing apparatus, comprising: a map information storage portion in which multiple pieces of map information, which is information displayed on a map and having at least one object containing positional information on the map, can be stored; an accepting portion that accepts a map output instruction, which is an instruction to output the map, and a map browse operation sequence, which is one or at least two operations to browse the map; a map output portion that reads the map information and outputs the map in a case where the accepting portion accepts the map output instruction; an operation information sequence acquiring portion that acquires an operation information sequence, which is information of one or at least two operations corresponding to the map browse operation sequence accepted by the accepting portion; a display attribute determining portion that selects at least one object and determines a display attribute of the at least one object in a case where the operation information sequence matches an object selecting condition, which is a predetermined condition for selecting an object; and a map output changing portion that acquires map information corresponding to the map browse operation, and outputs map information having the at least one object according to the display attribute of the at least one object determined by the display attribute determining portion.

With this configuration, a display attribute of an object on a map can be changed according to a map browse operation sequence, which is a group of at least one map browse operation, and thus a map corresponding to a purpose of a map operation performed by the user can be output.

Furthermore, a second aspect of the present invention is directed to the map information processing apparatus according to the first aspect, wherein the map information processing apparatus further includes a relationship information storage portion in which relationship information, which is information related to a relationship between at least two objects, can be stored, and the display attribute determining portion selects at least one object and determines a display attribute of the at least one object, using the operation information sequence and the relationship information between at least two objects.

With this configuration, the map information processing apparatus can change a display attribute of an object on a map also using relationship information between objects, and can output a map corresponding to a purpose of a map operation performed by the user.

Furthermore, a third aspect of the present invention is directed to the map information processing apparatus according to the second aspect, wherein multiple pieces of map information of the same region with different scales are stored in the map information storage portion, the map information processing apparatus further comprises a relationship information acquiring portion that acquires relationship information between at least two objects using an appearance pattern of the at least two objects in the multiple pieces of map information with different scales and positional information of the at least two objects, and the relationship information stored in the relationship information storage portion is the relationship information acquired by the relationship information acquiring portion.

With this configuration, the map information processing apparatus can automatically acquire relationship information between objects.

Furthermore, a fourth aspect of the present invention is directed to the map information processing apparatus according to the second aspect, wherein the relationship information includes a same-level relationship in which at least two objects are in the same level, a higher-level relationship in which one object is in a higher level than another object, and a lower-level relationship in which one object is in a lower level than another object.

With this configuration, the map information processing apparatus can use appropriate relationship information between objects.

Furthermore, a fifth aspect of the present invention is directed to the map information processing apparatus according the first aspect, wherein the display attribute determining portion comprises: an object selecting condition storage unit in which at least one object selecting condition containing an operation information sequence is stored; a judging unit that judges whether or not the operation information sequence matches any of the at least one object selecting condition; an object selecting unit that selects at least one object corresponding to the object selecting condition judged by the judging unit to be matched; and a display attribute value setting unit that sets a display attribute of the at least one object selected by the object selecting unit, to a display attribute value corresponding to the object selecting condition judged by the judging unit to be matched.

With this configuration, the map information processing apparatus can change a display attribute of an object on a map according to a map browse operation sequence, which is a group of at least one map browse operation, and can output a map corresponding to a purpose of a map operation performed by the user.

Furthermore, a sixth aspect of the present invention is directed to the map information processing apparatus according to the first aspect, wherein the display attribute value is an attribute value with which an object is displayed in an emphasized manner or an attribute value with which an object is displayed in a deemphasized manner.

With this configuration, the map information processing apparatus can output an easily understandable map corresponding to a purpose of a map operation performed by the user.

Furthermore, a seventh aspect of the present invention is directed to the map information processing apparatus according to the sixth aspect, wherein the display attribute determining portion sets a display attribute of at least one object that is not contained in the map information corresponding to a previously displayed map and that is contained in the map information corresponding to a newly displayed map, to an attribute value with which the at least one object is displayed in an emphasized manner.

With this configuration, the map information processing apparatus can output an easily understandable map corresponding to a purpose of a map operation performed by the user.

Furthermore, an eighth aspect of the present invention is directed to the map information processing apparatus according to the sixth aspect, wherein the display attribute determining portion sets a display attribute of at least one object that is contained in the map information corresponding to a previously displayed map and that is contained in the map information corresponding to a newly displayed map, to an attribute value with which the at least one object is displayed in a deemphasized manner.

With this configuration, the map information processing apparatus can output an easily understandable map corresponding to a purpose of a map operation performed by the user.

Furthermore, a ninth aspect of the present invention is directed to the map information processing apparatus according to the sixth aspect, wherein the display attribute determining portion selects at least one object that is contained in the map information corresponding to a newly displayed map and that satisfies a predetermined condition, and sets an attribute value of the at least one selected object to an attribute value with which the at least one object is displayed in an emphasized manner.

With this configuration, the map information processing apparatus can output an easily understandable map corresponding to a purpose of a map operation performed by the user.

Furthermore, a tenth aspect of the present invention is directed to the map information processing apparatus according to the first aspect, wherein the map browse operation includes a zoom-in operation (symbol [i]), a zoom-out operation (symbol [o]), a move operation (symbol [m]), and a centering operation (symbol [c]), and the operation information sequence includes any one of a multiple-point search operation information sequence, which is information indicating an operation sequence of c+o+[mc]+([+] refers to repeating an operation at least once), and is an operation information sequence corresponding to an operation to widen a search range from one point to a wider region; an interesting-point refinement operation information sequence, which is information indicating an operation sequence of c+o+([mc]*c+i+)+([*] refers to repeating an operation at least zero times), and is an operation information sequence corresponding to an operation to obtain detailed information of one point of interest; a simple movement operation information sequence, which is information indicating an operation sequence of [mc]+, and is an operation information sequence causing movement along multiple points; a selection movement operation information sequence, which is information indicating an operation sequence of [mc]+, and is an operation information sequence sequentially selecting multiple points; and a position confirmation operation information sequence, which is information indicating an operation sequence of [mc]+o+i+, and is an operation information sequence checking a relative position of one point.

With this configuration, an appropriate map according to a usage status of map information can be output.

Moreover, an eleventh aspect of the present invention is directed to a map information processing apparatus, comprising: a map information storage portion in which map information, which is information of a map, can be stored; an accepting portion that accepts a first information output instruction, which is an instruction to output first information, and a map browse operation sequence, which is multiple operations to browse the map; a first information output portion that outputs first information according to the first information output instruction; an operation information sequence acquiring portion that acquires an operation information sequence, which is information of multiple operations corresponding to the map browse operation sequence; a first keyword acquiring portion that acquires a keyword contained in the first information output instruction or a keyword corresponding to the first information; a second keyword acquiring portion that acquires at least one keyword from the map information, using the operation information sequence; a retrieving portion that retrieves information using at least two keywords acquired by the first keyword acquiring portion and the second keyword acquiring portion; and a second information output portion that outputs the information retrieved by the retrieving portion.

With this configuration, the map information processing apparatus can determine information that is to be output, also using information other than the operation information sequence.

Furthermore, a twelfth aspect of the present invention is directed to the map information processing apparatus according to the eleventh aspect, wherein the accepting portion also accepts a map output instruction to output the map, and the map information processing apparatus further comprises: a map output portion that reads the map information and outputs the map in a case where the accepting portion accepts the map output instruction; and a map output changing portion that changes output of the map according to a map browse operation in a case where the accepting portion accepts the map browse operation.

With this configuration, the map information processing apparatus can also change output of the map.

Furthermore, a thirteenth aspect of the present invention is directed to the map information processing apparatus according to the twelfth aspect, wherein the second keyword acquiring portion comprises: a search range management information storage unit in which at least two pieces of search range management information are stored, each of which is a pair of an operation information sequence and search range information, which is information of a map range of a keyword that is to be acquired; a search range information acquiring unit that acquires search range information corresponding to the operation information sequence that is at least one piece of operation information acquired by the operation information sequence acquiring portion, from the search range management information storage unit; and a keyword acquiring unit that acquires at least one keyword from the map information, according to the search range information acquired by the search range information acquiring unit.

With this configuration, the map information processing apparatus can define a keyword search range that matches an operation information sequence pattern, and can provide information that appropriately matches a purpose of a map operation performed by the user.

Furthermore, a fourteenth aspect of the present invention is directed to the map information processing apparatus according to the thirteenth aspect, wherein the map browse operation includes a zoom-in operation (symbol [i]), a zoom-out operation (symbol [o]), a move operation (symbol [m]), and a centering operation (symbol [c]), and the operation information sequence includes any one of: a single-point specifying operation information sequence, which is information indicating an operation sequence of m*c+i+([*] refers to repeating an operation at least zero times, and [+] refers to repeating an operation at least once), and is an operation information sequence specifying one given point; a multiple-point specifying operation information sequence, which is information indicating an operation sequence of m+o+, and is an operation information sequence specifying at least two given points; a selection specifying operation information sequence, which is information indicating an operation sequence of i+c[c*m*]*, and is an operation information sequence sequentially selecting multiple points; a surrounding-area specifying operation information sequence, which is information indicating an operation sequence of c+m*o+, and is an operation information sequence checking a positional relationship between multiple points; a wide-area specifying operation information sequence, which is information indicating an operation sequence of o+m+, and is an operation information sequence causing movement along multiple points; and a combination of at least two of the five types of operation information sequences.

With this configuration, the map information processing apparatus can provide information that appropriately matches a purpose of a map operation performed by the user.

Furthermore, a fifteenth aspect of the present invention is directed to the map information processing apparatus according to the fourteenth aspect, wherein the combination of the five types of operation information sequences is any one of a refinement search operation information sequence, which is an operation information sequence in which a single-point specifying operation information sequence is followed by a single-point specifying operation information sequence, and then the latter single-point specifying operation information sequence is followed by and partially overlapped with a selection specifying operation information sequence; a comparison search operation information sequence, which is an operation information sequence in which a selection specifying operation information sequence is followed by a multiple-point specifying operation information sequence, and then the multiple-point specifying operation information sequence is followed by and partially overlapped with a wide-area specifying operation information sequence; and a route search operation information sequence, which is an operation information sequence in which a surrounding-area specifying operation information sequence is followed by a selection specifying operation information sequence.

With this configuration, the map information processing apparatus can provide information that more appropriately matches a purpose of a map operation performed by the user.

Furthermore, a sixteenth aspect of the present invention is directed to the map information processing apparatus according to the fifteenth aspect, wherein in the search range management information storage unit, at least search range management information is stored that has a refinement search operation information sequence and refinement search target information as a pair, the refinement search target information being information to the effect that a keyword of a destination point is acquired that is a point near the center point of the map output in a centering operation accepted after a zoom-in operation or in a move operation accepted after a zoom-in operation, and in a case where it is judged that the operation information sequence that is at least two pieces of operation information acquired by the operation information sequence acquiring portion corresponds to the refinement search operation information sequence, the search range information acquiring unit acquires the refinement search target information, and the keyword acquiring unit acquires at least a keyword of a destination point corresponding to the refinement search target information acquired by the search range information acquiring unit.

With this configuration, the map information processing apparatus can acquire information that matches a purpose of a refinement search.

Furthermore, a seventeenth aspect of the present invention is directed to the map information processing apparatus according to the sixteenth aspect, wherein the refinement search target information also includes information to the effect that a keyword of a mark point is acquired that is a point near the center point of the map output in a centering operation accepted before a zoom-in operation, and the keyword acquiring unit also acquires a keyword of a mark point corresponding to the refinement search target information acquired by the search range information acquiring unit.

With this configuration, the map information processing apparatus can acquire information that matches a purpose of a refinement search.

Furthermore, an eighteenth aspect of the present invention is directed to the map information processing apparatus according to the fifteenth aspect, wherein in the search range management information storage unit, at least search range management information is stored that has a comparison search operation information sequence and comparison search target information as a pair, the comparison search target information being information indicating a region representing a difference between the region of the map output after a zoom-out operation and the region of the map output before the zoom-out operation, and in a case where it is judged that the operation information sequence that is at least two pieces of operation information acquired by the operation information sequence acquiring portion corresponds to the comparison search operation information sequence, the search range information acquiring unit acquires the comparison search target information, and the keyword acquiring unit acquires at least a keyword corresponding to the comparison search target information acquired by the search range information acquiring unit.

With this configuration, the map information processing apparatus can acquire information that matches a purpose of a comparison search.

Furthermore, a nineteenth aspect of the present invention is directed to the map information processing apparatus according to the fifteenth aspect, wherein in the search range management information storage unit, at least search range management information is stored that has a comparison search operation information sequence and comparison search target information as a pair, the comparison search target information being information indicating a region obtained by excluding the region of the map output before a move operation from the region of the map output after the move operation, and in a case where it is judged that the operation information sequence that is at least two pieces of operation information acquired by the operation information sequence acquiring portion corresponds to the comparison search operation information sequence, the search range information acquiring unit acquires the comparison search target information, and the keyword acquiring unit acquires at least a keyword corresponding to the comparison search target information acquired by the search range information acquiring unit.

With this configuration, the map information processing apparatus can acquire information that matches a purpose of a comparison search.

Furthermore, a twentieth aspect of the present invention is directed to the map information processing apparatus according to the eighteenth aspect, wherein the information retrieved by the retrieving portion is multiple web pages on the Internet, and in a case where a keyword corresponding to the comparison search target information acquired by the search range information acquiring unit is acquired, and the number of keywords acquired is only one, the keyword acquiring unit searches the multiple web pages for a keyword having the highest level of collocation with the one keyword, and acquires the keyword.

With this configuration, the map information processing apparatus can acquire information that matches a purpose of a comparison search.

Furthermore, a twenty-first aspect of the present invention is directed to the map information processing apparatus according to the fifteenth aspect, wherein in the search range management information storage unit, at least search range management information is stored that has a route search operation information sequence and route search target information as a pair, the route search target information being information to the effect that a keyword of a destination point is acquired that is a point near the center point of the map output in an accepted zoom-in operation or zoom-out operation, and in a case where it is judged that the operation information sequence that is at least one piece of operation information acquired by the operation information sequence acquiring portion corresponds to the route search operation information sequence, the search range information acquiring unit acquires the route search target information, and the keyword acquiring unit acquires at least a keyword of a destination point corresponding to the route search target information acquired by the search range information acquiring unit.

With this configuration, the map information processing apparatus can acquire information that matches a purpose of a route search.

Furthermore, a twenty-second aspect of the present invention is directed to the map information processing apparatus according to the twenty-first aspect, wherein the route search target information also includes information to the effect that a keyword of a mark point is acquired that is a point near the center point of the map output in a centering operation accepted before a zoom-in operation, and the keyword acquiring unit also acquires a keyword of a mark point corresponding to the route search target information acquired by the search range information acquiring unit.

With this configuration, the map information processing apparatus can acquire information that matches a purpose of a route search.

Furthermore, a twenty-third aspect of the present invention is directed to the map information processing apparatus according to the eleventh aspect, wherein the operation information sequence acquiring portion acquires an operation information sequence, which is a series of at least two pieces of operation information, and ends one automatically acquired operation information sequence in a case where a given condition is matched, and the second keyword acquiring portion acquires at least one keyword from the map information using the one operation information sequence.

With this configuration, the map information processing apparatus can automatically acquire a break in map operations of the user, and can retrieve more appropriate information.

Furthermore, a twenty-fourth aspect of the present invention is directed to the map information processing apparatus according to the twenty-third aspect, wherein the given condition is a situation in which a movement distance in a move operation is larger than a predetermined threshold value.

With this configuration, the map information processing apparatus can automatically acquire a break in map operations of the user, and can retrieve more appropriate information.

Furthermore, a twenty-fifth aspect of the present invention is directed to the map information processing apparatus according to the eleventh aspect, wherein the information to be retrieved by the retrieving portion is at least one web page on the Internet.

With this configuration, the map information processing apparatus can retrieve appropriate information from information storage apparatuses on the web.

Furthermore, a twenty-sixth aspect of the present invention is directed to the map information processing apparatus according to the sixteenth aspect, wherein the information to be retrieved by the retrieving portion is at least one web page on the Internet, and in a case where the accepting portion accepts a refinement search operation information sequence, the retrieving portion retrieves a web page that has the keyword of the destination point in a title thereof and the keyword of the mark point and the keyword acquired by the first keyword acquiring portion in a page thereof.

With this configuration, the map information processing apparatus can acquire appropriate web pages.

Furthermore, a twenty-seventh aspect of the present invention is directed to the map information processing apparatus according to the sixteenth aspect, wherein the map information has map image information indicating an image of the map, and term information having a term on the map and positional information indicating the position of the term, the information to be retrieved by the retrieving portion is at least one web page on the Internet, and the retrieving portion acquires at least one web page that contains all of the keyword acquired by the first keyword acquiring portion, the keyword of the mark point, and the keyword of the destination point, detects at least two terms from each of the at least one web page that has been acquired, acquires at least two pieces of positional information indicating the positions of the at least two terms, from the map information, acquires geographical range information, which is information indicating a geographical range of a description of a web page, for each web page, using the at least two pieces of positional information, and acquires at least a web page in which the geographical range information indicates the smallest geographical range.

With this configuration, the map information processing apparatus can acquire appropriate web pages.

Furthermore, a twenty-eighth aspect of the present invention is directed to the map information processing apparatus according to the twenty-seventh aspect, wherein in a case where at least one web page that contains the keyword acquired by the first keyword acquiring portion, the keyword of the mark point, and the keyword of the destination point is acquired, the retrieving portion acquires at least one web page that has at least one of the keywords in a title thereof.

With this configuration, the map information processing apparatus can acquire more appropriate web pages.

With the map information processing apparatus according to the present invention, appropriate information can be presented.

### BRIEF DESCRIPTION OF THE DRAWINGS

FIG. 1 is a conceptual diagram of a map information processing system in Embodiment 1.

FIG. 2 is a block diagram of the map information processing system in Embodiment 1.

FIG. 3 is a diagram showing a relationship judgment management table in Embodiment 1.

FIG. 4 is a flowchart illustrating an operation of a map information processing apparatus in Embodiment 1.

FIG. 5 is a flowchart illustrating an operation of a relationship information forming process in Embodiment 1.

FIG. 6 is a diagram showing an example of map information in Embodiment 1.

FIG. 7 is a diagram showing an object selecting condition management table in Embodiment 1.

FIG. 8 is a diagram showing a relationship information management table in Embodiment 1.

FIG. 9 is a diagram showing an object display attribute management table in Embodiment 1.

FIG. 10 is a view showing an output image in Embodiment 1.

FIG. 11 is a view showing an output image in Embodiment 1.

FIG. 12 is a view showing an output image in Embodiment 1.

FIG. 13 is a view showing an output image in Embodiment 1.

FIG. 14 is a conceptual diagram of a map information processing system in Embodiment 2.

FIG. 15 is a block diagram of the map information processing system in Embodiment 2.

FIG. 16 is a flowchart illustrating an operation of a map information processing apparatus in Embodiment 2.

FIG. 17 is a flowchart illustrating an operation of a keyword acquiring process in Embodiment 2.

FIG. 18 is a flowchart illustrating an operation of a search range information acquiring process in Embodiment 2.

FIG. 19 is a flowchart illustrating an operation of a keyword acquiring process in Embodiment 2.

FIG. 20 is a flowchart illustrating an operation of a keyword acquiring process inside a region in Embodiment 2.

FIG. 21 is a flowchart illustrating an operation of a search process in Embodiment 2.

FIG. 22 is a schematic view the map information processing apparatus in Embodiment 2.

FIG. 23 is a view showing examples of map image information in Embodiment 2.

FIG. 24 is a diagram showing an example of term information in Embodiment 2.

FIG. 25 is a diagram showing an atomic operation chunk management table in Embodiment 2.

FIG. 26 is a diagram showing a complex operation chunk management table in Embodiment 2.

FIG. 27 is a view showing an output image in Embodiment 2.

FIG. 28 is a diagram showing an example of the data structure within a buffer in Embodiment 2.

FIG. 29 is a diagram showing an example of the data structure within a buffer in Embodiment 2.

FIG. 30 is a view showing an output image in Embodiment 2.

FIG. 31 is a view illustrating a region in which a keyword is acquired in Embodiment 2.

FIG. 32 is a view illustrating a region in which a keyword is acquired in Embodiment 2.

FIG. 33 is a diagram showing an example of the data structure within a buffer in Embodiment 2.

FIG. 34 is a diagram showing an example of the data structure within a buffer in Embodiment 2.

FIG. 35 is a schematic view of a computer system in Embodiments 1 and 2.

FIG. 36 is a block diagram of the computer system in Embodiments 1 and 2.

### DETAILED DESCRIPTION OF THE INVENTION

Hereinafter, embodiments of a map information processing system and the like will be described with reference to the drawings. It should be noted that constituent elements denoted by the same reference numerals in the embodiments perform similar operations, and thus a description thereof may not be repeated.

### Embodiment 1

In this embodiment, a map information processing system for changing a display attribute of an object (a geographical name, an image, etc.) on a map according to a map browse operation sequence, which is a group of one or more map browse operations, will be described. In this map information processing system, for example, relationship information between objects is used to change the display attribute. Furthermore, in this embodiment, a function to automatically acquire the relationship information between objects also will be described.

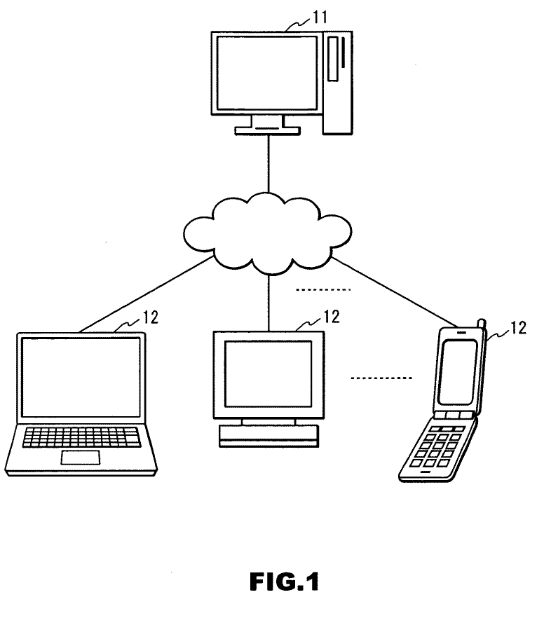

FIG. 1 is a conceptual diagram of a map information processing system 1 in this embodiment. The map information processing system 1 includes a map information processing apparatus 11 and one or more terminal apparatuses 12. The map information processing apparatus 11 may be a stand-alone apparatus. Furthermore, the map information processing system 1 or the map information processing apparatus 11 may constitute a navigation system. The terminal apparatuses 12 are terminals used by users.

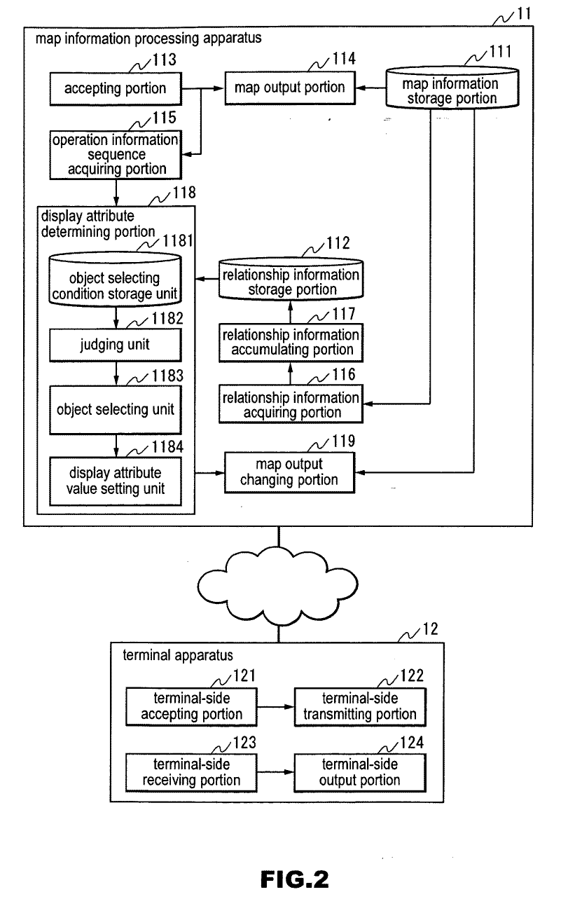

FIG. 2 is a block diagram of the map information processing system 1 in this embodiment. The map information processing apparatus 11 includes a map information storage portion 111, a relationship information storage portion 112, an accepting portion 113, a map output portion 114, an operation information sequence acquiring portion 115, a relationship information acquiring portion 116, a relationship information accumulating portion 117, a display attribute determining portion 118, and a map output changing portion 119.

The display attribute determining portion 118 includes an object selecting condition storage unit 1181, a judging unit 1182, an object selecting unit 1183, and a display attribute value setting unit 1184.

The terminal apparatus 12 includes a terminal-side accepting portion 121, a terminal-side transmitting portion 122, a terminal-side receiving portion 123, and a terminal-side output portion 124.

In the map information storage portion 111, multiple pieces of map information can be stored. The map information is information displayed on a map, and has one or more objects containing positional information on the map. The map information has, for example, map image information showing an image of a map, and an object. The map image information is, for example, bitmap or vector data constituting a map. The object is a character string of a geographical name or a name of scenic beauty, an image (also including a mark, etc.) on a map, a partial region, or the like. The object is a portion constituting a map, and information appearing on the map. There is no limitation on the data type of the object, and it is possible to use a character string, an image, a moving image, and the like. The object has, for example, a term (a character string of a geographical name, a name of scenic beauty, etc.). The object may be considered to have only a term, or to have a term and positional information. The term is a character string of, for example, a geographical name, a building name, a name of scenic beauty, or a location name, or the like indicated on the map. Furthermore, positional information is information having the longitude and the latitude on a map, XY coordinate values on a two-dimensional plane (point information), information indicating a region (region information), or the like. The point information is information of a point on a map. The region information is, for example, information of two points indicating a rectangle on a map (e.g., the longitude and the latitude of the upper left point and the longitude and the latitude of the lower right point). Furthermore, the map information also may be an ISO kiwi map data format. Furthermore, the map information preferably has the map image information and the term information for each scale. Furthermore, ‘output an object’ typically refers to outputting a term that is contained in the object to the position corresponding to positional information that is contained in the object. In the map information storage portion 111, typically, multiple pieces of map information of the same region with different scales are stored. Furthermore, typically, the map image information is stored as a pair with scale information, which is information indicating a scale of a map. The map information storage portion 111 is preferably a non-volatile storage medium, but can be realized also as a volatile storage medium. There is no limitation on the procedure in which the map information is stored in the map information storage portion 111. For example, the map information may be stored in the map information storage portion 111 via a storage medium, the map information transmitted via a communication line or the like may be stored in the map information storage portion 111, or the map information input via an input device may be stored in the map information storage portion 111.

In the relationship information storage portion 112, relationship information can be stored. The relationship information is information related to the relationship between two or more objects. The relationship information is, for example, a same-level relationship, a higher-level relationship, a lower-level relationship, a no-relationship, or the like. The same-level relationship is a relationship in which two or more objects are in the same level. The higher-level relationship is a relationship in which one object is in a higher level than another object. The lower-level relationship is a relationship in which one object is in a lower level than another object. The relationship information storage portion 112 is preferably a non-volatile storage medium, but can be realized also as a volatile storage medium. There is no limitation on the procedure in which the relationship information is stored in the relationship information storage portion 112. For example, the relationship information may be stored in the relationship information storage portion 112 via a storage medium, the relationship information transmitted via a communication line or the like may be stored in the relationship information storage portion 112, or the relationship information input via an input device may be stored in the relationship information storage portion 112.

The accepting portion 113 accepts various types of instruction, information, and the like. The various types of instruction or information is, for example, a map output instruction, which is an instruction to output a map, a map browse operation sequence, which is one or at least two operations to browse a map, or the like. For example, the accepting portion 113 may accept various types of instruction, information, and the like from a user, and may receive various types of instruction, information, and the like from the terminal apparatus 12. Furthermore, the accepting portion 113 may accept an operation and the like from a navigation system (not shown). That is to say, the current position moves according to the travel of a vehicle, this movement is, for example, a move operation or centering operation of a map, and the accepting portion 113 may accept this move operation or centering operation from the navigation system. The accepting portion 113 may be realized as a wireless or wired communication unit.

If the accepting portion 113 accepts a map output instruction, the map output portion 114 reads map information corresponding to the map output instruction from the map information storage portion 111 and outputs a map. The function of the map output portion 114 is a known art, and thus a detailed description thereof has been omitted. Here, ‘output’ has a concept that includes, for example, output to a display, projection using a projector, printing in a printer, outputting a sound, transmission to an external apparatus (the terminal apparatus 12, etc.), accumulation in a storage medium, and delivery of a processing result to another processing apparatus or another program. The map output portion 114 may be realized, for example, as a wireless or wired communication unit.

The operation information sequence acquiring portion 115 acquires an operation information sequence, which is information of one or at least two operations corresponding to the map browse operation sequence accepted by the accepting portion 113. The map browse operation includes, for example, a zoom-in operation (symbol [i]), a zoom-out operation (symbol [o]), a move operation (symbol [m]), a centering operation (symbol [c]), and the like. The map browse operation may be considered to also include information generated by the travel of a moving object such as a vehicle. The operation information sequence preferably includes, for example, any of a multiple-point search operation information sequence, an interesting-point refinement operation information sequence, a simple movement operation information sequence, a selection movement operation information sequence, and a position confirmation operation information sequence. The multiple-point search operation information sequence is information indicating an operation sequence of c+o+[mc]+([+] refers to repeating an operation one or more times), and is an operation information sequence corresponding to an operation to widen the search range from one point to a wider region. The interesting-point refinement operation information sequence is information indicating an operation sequence of c+o+([mc]*c+i+)+([*] refers to repeating an operation zero or more times), and is an operation information sequence corresponding to an operation to obtain detailed information of one point of interest. The simple movement operation information sequence is information indicating an operation sequence of [mc]+, and is an operation information sequence causing movement along multiple points. The selection movement operation information sequence is information indicating an operation sequence of [mc]+, and is an operation information sequence sequentially selecting multiple points. The position confirmation operation information sequence is information indicating an operation sequence of [mc]+o+i+, and is an operation information sequence checking a relative position of one point. The operation information sequence acquiring portion 115 can be realized typically as an MPU, a memory, or the like. Typically, the processing procedure of the operation information sequence acquiring portion 115 is realized by software, and the software is stored in a storage medium such as a ROM. Note that the processing procedure also may be realized by hardware (dedicated circuit).

The relationship information acquiring portion 116 acquires relationship information between two or more objects. The relationship information is information indicating the relationship between two or more objects. The relationship information includes, for example, a same-level relationship in which two or more objects are in the same level, a higher-level relationship in which one object is in a higher level than another object, a lower-level relationship in which one object is in a lower level than another object, a no-relationship, and the like. The relationship information acquiring portion 116 acquires relationship information between two or more objects, for example, using an appearance pattern of the two or more objects in multiple pieces of map information with different scales and positional information of the two or more objects. The appearance pattern of objects is, for example, an equal relationship, a wider scale relationship, or a more detailed scale relationship. The equal relationship refers to the relationship between two objects (e.g., a geographical name, a name of scenic beauty) in a case where patterns of scales in which the two objects appear completely match each other. With respect to a first object, if there is a second object that appears also in a scale showing a wider region than that of the first object, the second object has a ‘wider scale relationship’ with respect to the first object. With respect to a first object, if there is a second object that appears also in a scale indicating more detailed information than that of the first object, the second object has a ‘more detailed scale relationship’ with respect to the first object. Herein, the positional information of two or more objects is, for example, the relationship between regions of the two or more objects. The relationship between regions includes, for example, independent (adjacent), including, match, and overlap. If geographical name regions are not overlapped as in the case of Chion-in Temple and Nijo-jo Castle, the two objects have the ‘independent’ relationship. Furthermore, if one geographical name region completely includes another geographical name region as in the case of Kyoto-gyoen National Garden and Kyoto Imperial Palace, the two objects have the ‘including’ relationship. ‘Included’ refers to a relationship opposite to ‘including’. ‘Match’ refers to a relationship in which regions indicated by the positional information of two objects are completely the same. Geographical names (objects) in which a region under the ground and a region on the ground are partially overlapped as in the case of Osaka Station and Umeda Station have the ‘overlap’ relationship.

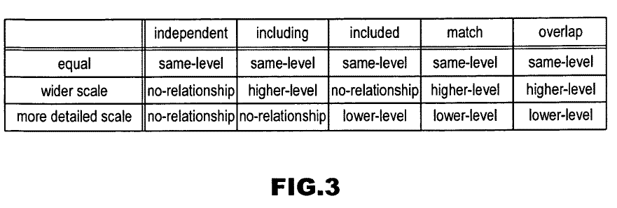

The relationship information acquiring portion 116 holds a relationship judgment management table, for example, as shown in FIG. 3. The relationship information acquiring portion 116 acquires relationship information based on the appearance pattern and the positional information of two objects using the relationship judgment management table. In the relationship judgment management table, the rows indicate the appearance pattern of objects, and the columns indicates the positional information (the relationship between two regions). That is to say, if the appearance pattern of two objects is the equal relationship, the relationship information acquiring portion 116 judges that the relationship between the two objects is the same-level relationship, regardless of the positional information, based on the relationship judgment management table. If the appearance pattern of two objects is the wider scale relationship, and the positional information is including, match, or overlap, the relationship information acquiring portion 116 judges that the relationship between the two objects is the higher-level relationship. If the appearance pattern of two objects is the more detailed scale relationship, and the positional information is included, match, or overlap, the relationship information acquiring portion 116 judges that the relationship between the two objects is the lower-level relationship. Otherwise, the relationship information acquiring portion 116 judges that the relationship between the two objects is the no-relationship. Then, the relationship information acquiring portion 116 acquires relationship information (the information in FIG. 3) corresponding to the judgment. There is no limitation on the timing at which the relationship information acquiring portion 116 acquires the relationship information. The relationship information acquiring portion 116 can be realized typically as an MPU, a memory, or the like. Typically, the processing procedure of the relationship information acquiring portion 116 is realized by software, and the software is stored in a storage medium such as a ROM. Note that the processing procedure also may be realized by hardware (dedicated circuit).

The relationship information accumulating portion 117 at least temporarily accumulates the relationship information acquired by the relationship information acquiring portion 116 in the relationship information storage portion 112. The relationship information accumulating portion 117 can be realized typically as an MPU, a memory, or the like. Typically, the processing procedure of the relationship information accumulating portion 117 is realized by software, and the software is stored in a storage medium such as a ROM. Note that the processing procedure also may be realized by hardware (dedicated circuit).

If an operation information sequence matches an object selecting condition, which is a predetermined condition for selecting an object, the display attribute determining portion 118 selects one or more objects and determines a display attribute of the one or more objects. The display attribute determining portion 118 typically holds display attributes of objects corresponding to object selecting conditions. Furthermore, the display attribute determining portion 118 selects one or more objects and determines a display attribute of the one or more objects, for example, using the operation information sequence and the relationship information between two or more objects. Here, ‘determine’ may refer to setting of a display attribute as an attribute of an object. Furthermore, the display attribute is, for example, the attribute of a character string (the font, the color, the size, etc.), the attribute of a graphic form that encloses a character string (the shape, the color, the line type of a graphic form, etc.), the attribute of a region (the color, the line type of a region boundary, etc.), or the like. More specifically, for example, the display attribute determining portion 118 sets an attribute value of one or more objects that are not contained in the map information corresponding to a previously displayed map and that are contained in the map information corresponding to a newly displayed map, to an attribute value with which the one or more objects are displayed in an emphasized manner. The attribute value for emphasized display is an attribute value with which the objects are displayed in a status more outstanding than that of the others, for example, in which a character string is displayed in a BOLD font, letters are displayed in red, the background is displayed in a color (red, etc.) more outstanding than that of the others, the size of letters is increased, a character string is flashed, or the like. More specifically, for example, the display attribute determining portion 118 sets an attribute value of one or more objects that are contained in the map information corresponding to a previously displayed map and that are contained in the map information corresponding to a newly displayed map, to an attribute value with which the one or more objects are displayed in a deemphasized manner. The attribute value for deemphasized display is an attribute value with which the objects are displayed in a status less outstanding than that of the others, for example, in which letters or a region is displayed in a pale color such as gray, the font size is reduced, a character string or a region is made semitransparent, or the like. More specifically, for example, the display attribute determining portion 118 selects one or more objects that are contained in the map information corresponding to a newly displayed map and that satisfy a predetermined condition, and sets an attribute value of the one or more selected objects to an attribute value with which the one or more objects are displayed in an emphasized manner. Here, a predetermined condition is, for example, a condition in which the object such as a geographical name is present at a position closest to the center point of a map in a case where an centering operation is input. The display attribute determining portion 118 may be considered to include, or to not include, a display device. The display attribute determining portion 118 may be realized, for example, as driver software for a display device, or a combination of driver software for a display device and the display device.

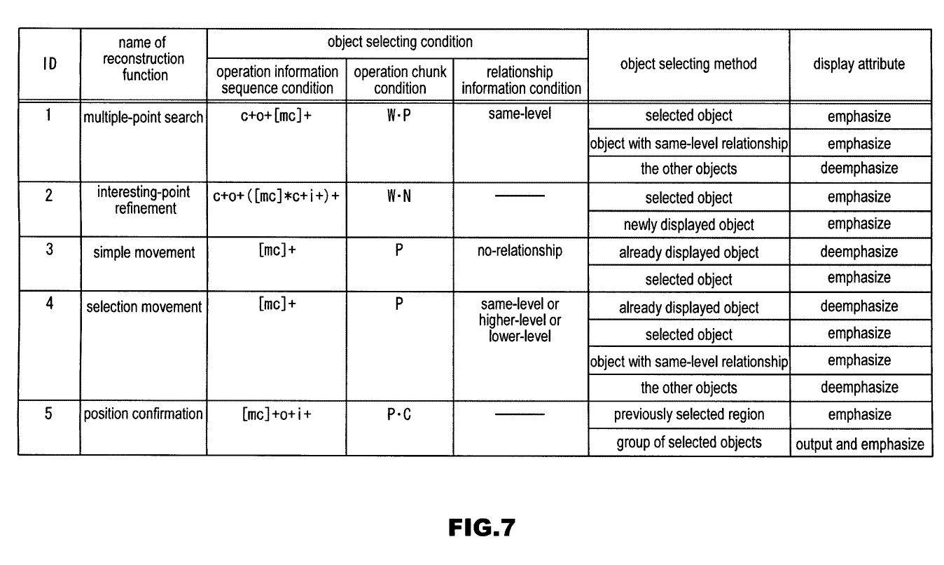

In the object selecting condition storage unit 1181, one or more object selecting conditions containing an operation information sequence are stored. The object selecting condition is a predetermined condition for selecting an object. The object selecting condition storage unit 1181 preferably has, as a group, an object selecting condition, selection designating information (corresponding to the object selecting method in FIG. 7 described later), which is information designating an object that is to be selected, and a display attribute value. The object selecting condition storage unit 1181 is preferably a non-volatile storage medium, but can be realized also as a volatile storage medium. There is no limitation on the procedure in which the object selecting condition is stored in the object selecting condition storage unit 1181. For example, the object selecting condition may be stored in the object selecting condition storage unit 1181 via a storage medium, the object selecting condition transmitted via a communication line or the like may be stored in the object selecting condition storage unit 1181, or the object selecting condition input via an input device may be stored in the object selecting condition storage unit 1181.

The judging unit 1182 judges whether or not the operation information sequence acquired by the operation information sequence acquiring portion 115 matches one or more object selecting conditions. The judging unit 1182 can be realized typically as an MPU, a memory, or the like. Typically, the processing procedure of the judging unit 1182 is realized by software, and the software is stored in a storage medium such as a ROM. Note that the processing procedure also may be realized by hardware (dedicated circuit).

The object selecting unit 1183 selects one or more objects corresponding to the object selecting condition judged by the judging unit 1182 to be matched. The object selecting unit 1183 can be realized typically as an MPU, a memory, or the like. Typically, the processing procedure of the object selecting unit 1183 is realized by software, and the software is stored in a storage medium such as a ROM. Note that the processing procedure also may be realized by hardware (dedicated circuit).

The display attribute value setting unit 1184 sets a display attribute of the one or more objects selected by the object selecting unit 1183, to a display attribute value corresponding to the object selecting condition judged by the judging unit 1182 to be matched. The display attribute value setting unit 1184 may set a display attribute of the one or more objects selected by the object selecting unit 1183, to a predetermined display attribute value. The display attribute value setting unit 1184 may be considered to include, or to not include, a display device. The display attribute value setting unit 1184 may be realized, for example, as driver software for a display device, or a combination of driver software for a display device and the display device.

The map output changing portion 119 acquires map information corresponding to the map browse operation, and outputs map information having the one or more objects according to the display attribute of the one or more objects determined by the display attribute determining portion 118. Here, ‘output’ has a concept that includes, for example, output to a display, projection using a projector, printing in a printer, outputting a sound, transmission to an external apparatus (e.g., display apparatus), accumulation in a storage medium, and delivery of a processing result to another processing apparatus or another program. The map output changing portion 119 may be considered to include, or to not include, an output device such as a display or a loudspeaker. The map output changing portion 119 may be realized, for example, as driver software for an output device, or a combination of driver software for an output device and the output device.

The terminal-side accepting portion 121 accepts an instruction, a map operation, and the like from the user. The terminal-side accepting portion 121 accepts, for example, a map output instruction, which is an instruction to output a map, and a map browse operation sequence, which is one or at least two operations to browse the map. There is no limitation on the input unit of the instruction and the like, and it is possible to use a keyboard, a mouse, a menu screen, and the like. The terminal-side accepting portion 121 may be realized as a device driver of an input unit such as a keyboard, control software for a menu screen, or the like. It will be appreciated that the terminal-side accepting portion 121 may accept a signal from a touch panel.

The terminal-side transmitting portion 122 transmits the instruction and the like accepted by the terminal-side accepting portion 121, to the map information processing apparatus 11. The terminal-side transmitting portion 122 is typically realized as a wireless or wired communication unit, but also may be realized as a broadcasting unit.

The terminal-side receiving portion 123 receives map information and the like from the map information processing apparatus 11. The terminal-side receiving portion 123 is typically realized as a wireless or wired communication unit, but also may be realized as a broadcast receiving unit.

The terminal-side output portion 124 outputs the map information received by the terminal-side receiving portion 123. Here, ‘output’ has a concept that includes, for example, output to a display, projection using a projector, printing in a printer, outputting a sound, transmission to an external apparatus, accumulation in a storage medium, and delivery of a processing result to another processing apparatus or another program. The terminal-side output portion 124 may be considered to include, or to not include, an output device such as a display or a loudspeaker. The terminal-side output portion 124 may be realized for example, as driver software for an output device, or a combination of driver software for an output device and the output device.

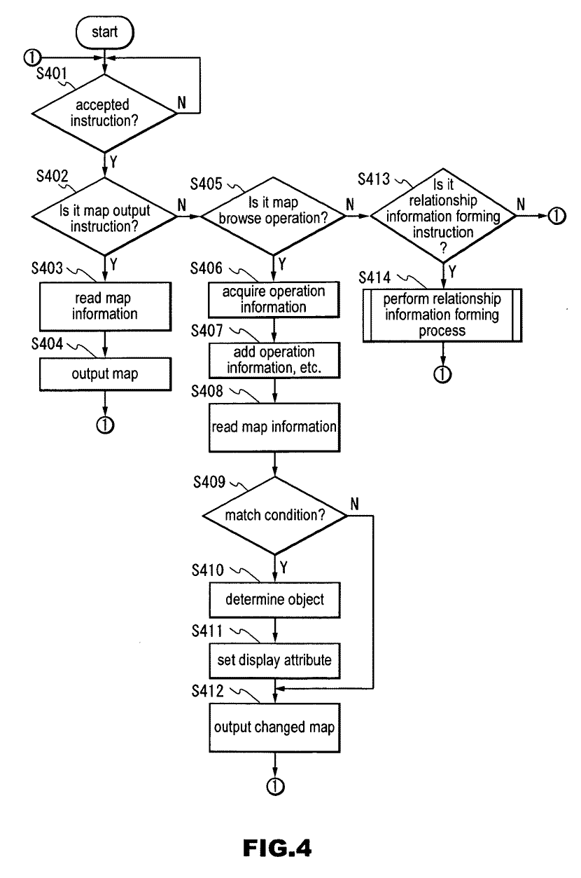

Next, the operation of the map information processing apparatus 11 will be described with reference to the flowchart in FIG. 4. It should be noted that the terminal apparatus 12 is a known terminal, and thus a description of its operation has been omitted.

(Step S401) The accepting portion 113 judges whether or not an instruction or the like is accepted. If an instruction or the like is accepted, the procedure proceeds to step S402. If an instruction or the like is not accepted, the procedure returns to step S401.

(Step S402) The map output portion 114 judges whether or not the instruction accepted in step S401 is a map output instruction. If the instruction is a map output instruction, the procedure proceeds to step S403. If the instruction is not a map output instruction, the procedure proceeds to step S405.

(Step S403) The map output portion 114 reads map information corresponding to the map output instruction, from the map information storage portion 111. The map information read by the map output portion 114 may be default map information (map information constituting an initial screen).

(Step S404) The map output portion 114 outputs a map using the map information read in step S403. The procedure returns to step S401.

(Step S405) The operation information sequence acquiring portion 115 judges whether or not the instruction accepted in step S401 is a map browse operation. If the instruction is a map browse operation, the procedure proceeds to step S406. If the instruction is not a map browse operation, the procedure proceeds to step S413.

(Step S406) The operation information sequence acquiring portion 115 acquires operation information corresponding to the map browse operation accepted in step S401.

(Step S407) The operation information sequence acquiring portion 115 adds the operation information acquired in step S406, to a buffer in which operation information sequences are stored.

(Step S408) The map output changing portion 119 reads map information corresponding to the map browse operation accepted in step S401, from the map information storage portion 111.

(Step S409) The display attribute determining portion 118 judges whether or not the operation information sequence in the buffer matches any of the object selecting conditions. If the operation information sequence matches any of the object selecting conditions, the procedure proceeds to step S410. If the operation information sequence matches none of the object selecting conditions, the procedure proceeds to step S412.

(Step S410) The display attribute determining portion 118 acquires one or more objects corresponding to the object selecting condition judged to be matched in step S409, from the map information read in step S408. The display attribute determining portion 118 acquires, for example, an object (herein, may be a geographical name only) having the positional information closest to the center point of the map information.

(Step S411) The display attribute determining portion 118 sets a display attribute of the one or more objects acquired in step S410, to the display attribute corresponding to the object selecting condition judged to be matched in step S409.

(Step S412) The map output changing portion 119 outputs changed map information. The changed map information is the map information read in step S408, or the map information containing the object whose display attribute has been set in step S411. The procedure returns to step S401.

(Step S413) The relationship information acquiring portion 116 judges whether or not the instruction accepted in step S401 is a relationship information forming instruction. If the instruction is a relationship information forming instruction, the procedure proceeds to step S414. If the instruction is not a relationship information forming instruction, the procedure returns to step S401.

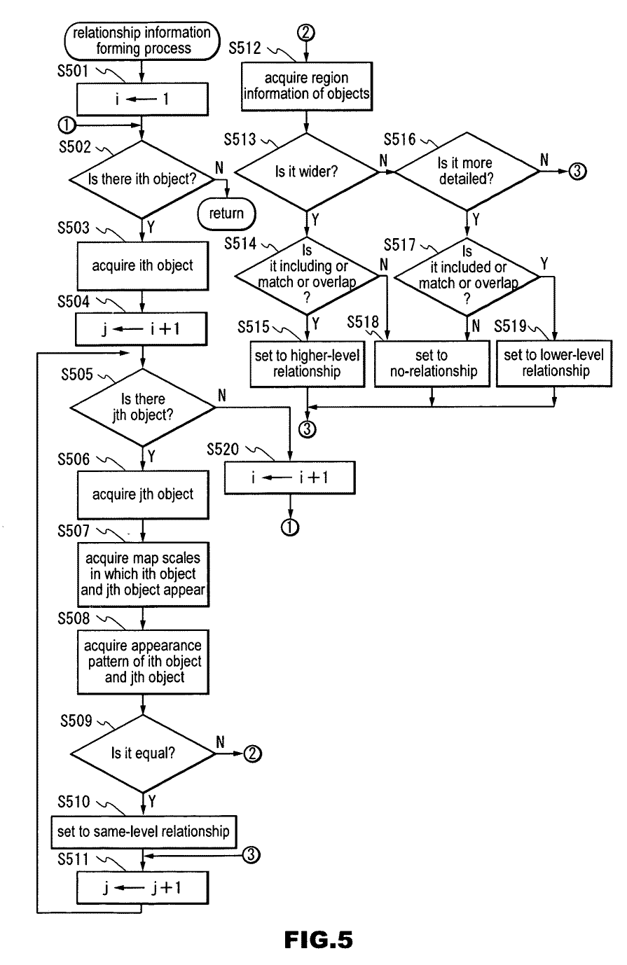

(Step S414) The relationship information acquiring portion 116 and the like perform a relationship information forming process. The procedure returns to step S401. The relationship information forming process will be described in detail with reference to the flowchart in FIG. 5.

In the flowchart in FIG. 4, the relationship information forming process is not an essential process. The relationship information may be manually prepared in advance.

Note that the process is ended by powering off or interruption for aborting the process in the flowchart in FIG. 4.

Next, the relationship information forming process in step S414 will be described in detail with reference to the flowchart in FIG. 5.

(Step S501) The relationship information acquiring portion 116 substitutes 1 for the counter i.

(Step S502) The relationship information acquiring portion 116 judges whether or not the ith object is present in any object contained in the map information in the map information storage portion 111. If the ith object is present, the procedure proceeds to step S503. If the ith object is not present, the procedure returns to the upper-level process.

(Step S503) The relationship information acquiring portion 116 acquires the ith object from the map information storage portion 111, and arranges it in the memory.

(Step S504) The relationship information acquiring portion 116 substitutes i+1 for the counter j.

(Step S505) The relationship information acquiring portion 116 judges whether or not the jth object is present in any object contained in the map information in the map information storage portion 111. If the jth object is present, the procedure proceeds to step S506. If the jth object is not present, the procedure proceeds to step S520.

(Step S506) The relationship information acquiring portion 116 acquires the jth object from the map information storage portion 111, and arranges it in the memory.

(Step S507) The relationship information acquiring portion 116 acquires map scales in which the ith object and the jth object appear (scale information) from the map information storage portion 111.

(Step S508) The relationship information acquiring portion 116 acquires an appearance pattern (e.g., any of the equal relationship, the wider scale relationship, and the more detailed scale relationship) using the scale information of the ith object and the jth object acquired in step S507.

(Step S509) The relationship information acquiring portion 116 judges whether or not the appearance pattern acquired in step S508 is the equal relationship. If the appearance pattern is the equal relationship, the procedure proceeds to step S510. If the appearance pattern is not the equal relationship, the procedure proceeds step S512.

(Step S510) The relationship information acquiring portion 116 sets the relationship information between the ith object and the jth object, to the same-level relationship. Here, ‘to set the relationship information to the same-level relationship’ refers to, for example, a state in which the ith object and the jth object are added as a pair to a buffer (not shown) in which objects having the same-level relationship are stored. Furthermore, the process ‘to set the relationship information to the same-level relationship’ may be any process, as long as it can be seen that the objects have the same-level relationship.

(Step S511) The relationship information acquiring portion 116 increments the counter j by 1. The procedure returns to step S505.

(Step S512) The relationship information acquiring portion 116 acquires the region information of the ith object and the jth object. The ith object and the jth object may not have the region information.

(Step S513) The relationship information acquiring portion 116 judges whether or not the appearance pattern acquired in step S508 is the wider scale relationship. If the appearance pattern is the wider scale relationship, the procedure proceeds to step S514. If the appearance pattern is not the wider scale relationship, the procedure proceeds to step S516.

(Step S514) The relationship information acquiring portion 116 judges whether or not the ith object and the jth object have the regional relationship ‘including’, ‘match’, or ‘overlap’, using the region information of the objects. If the objects have the regional relationship ‘including’, ‘match’, or ‘overlap’, the procedure proceeds to step S515. If the objects do not have this sort of relationship, the procedure proceeds to step S518.

(Step S515) The relationship information acquiring portion 116 sets the relationship information between the ith object and the jth object, to the higher-level relationship. Here, ‘to set the relationship information to the higher-level relationship’ refers to, for example, a state in which the ith object and the jth object are added as a pair to a buffer (not shown) in which objects having the higher-level relationship are stored. Furthermore, the process ‘to set the relationship information to the higher-level relationship’ may be any process, as long as it can be seen that the objects have the higher-level relationship. The procedure proceeds to step S511.

(Step S516) The relationship information acquiring portion 116 judges whether or not the appearance pattern acquired in step S508 is the more detailed scale relationship. If the appearance pattern is the more detailed scale relationship, the procedure proceeds to step S517. If the appearance pattern is not the more detailed scale relationship, the procedure proceeds to step S511.

(Step S517) The relationship information acquiring portion 116 judges whether or not the ith object and the jth object have the regional relationship ‘included’, ‘match’, or ‘overlap’, using the region information of the objects. If the objects have the regional relationship ‘included’, ‘match’, or ‘overlap’, the procedure proceeds to step S519. If the objects do not have this sort of relationship, the procedure proceeds to step S518.

(Step S518) The relationship information acquiring portion 116 sets the relationship information between the ith object and the jth object, to the no-relationship. Here, ‘to set to the no-relationship’ may refer to a state in which no process is performed, or may refer to a state in which the ith object and the jth object are added as a pair to a buffer (not shown) in which objects having the no-relationship are stored. The procedure proceeds to step S511.

(Step S519) The relationship information acquiring portion 116 sets the relationship information between the ith object and the jth object, to the lower-level relationship. Here, ‘to set the relationship information to the lower-level relationship’ refers to, for example, a state in which the ith object and the jth object are added as a pair to a buffer (not shown) in which objects having the lower-level relationship are stored. Furthermore, the process ‘to set the relationship information to the lower-level relationship’ may be any process, as long as it can be seen that the objects have the lower-level relationship. The procedure proceeds to step S511.

(Step S520) The relationship information acquiring portion 116 increments the counter i by 1. The procedure returns to step S502.

The relationship information forming process described with reference to the flowchart in FIG. 5 may be performed each time the map information processing apparatus 11 selects an object and acquires the relationship between the selected object and a previously selected (preferably, most recently selected) object. That is to say, there is no limitation on the timing at which the relationship information forming process is performed.

Hereinafter, specific operations of the map information processing system 1 in this embodiment will be described. FIG. 1 is a conceptual diagram of the map information processing system 1.

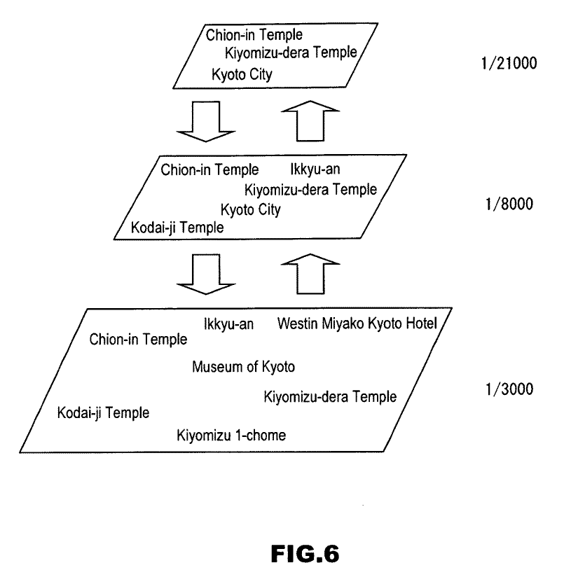

It is assumed that, for example, the map information shown in FIG. 6 constituting a map of Kyoto is stored in the map information storage portion 111. The map information has three scales. In FIG. 6, Chion-in Temple, Kyoto City, and Kiyomizu-dera Temple appear in the map of 1/21000. In FIG. 6, the objects (geographical names) that appear in all scales are Chion-in Temple and Kiyomizu-dera Temple. The object that appears in the maps of 1/21000 and 1/8000 is Kyoto City. The objects that appear in the maps of 1/8000 and 1/3000 are Kodai-ji Temple and Ikkyu-an. The object that appears only in the map of 1/3000 is the Westin Miyako Kyoto Hotel. The map information has the map image information and the objects. Herein, the object has the term and the positional information. It is assumed that the positional information has the point information (the latitude and the longitude) and the region information of the term (a geographical name, etc.).

It is assumed that, in this status, the user inputs a relationship information forming instruction to the terminal apparatus 12. The terminal-side accepting portion 121 of the terminal apparatus 12 accepts the relationship information forming instruction. Next, the terminal-side transmitting portion 122 transmits the relationship information forming instruction to the map information processing apparatus 11. The accepting portion 113 of the map information processing apparatus 11 receives the relationship information forming instruction. The relationship information acquiring portion 116 and the like of the map information processing apparatus 11 form the relationship information between objects as follows, according to the flowchart in FIG. 5.

That is to say, since the scale appearance patterns of the objects of Kiyomizu-dera Temple and Chion-in Temple completely match each other, the relationship information acquiring portion 116 determines that the objects have the equal relationship. The relationship information acquiring portion 116 determines that, for example, the object ‘Kiyomizu-dera Temple’ that appears in the maps with a scale of 1/3000 to 1/21000 has a wider scale relationship relative to the object ‘Ikkyu-an’ that appears in the maps with a scale of 1/3000 and 1/8000. Furthermore, the relationship information acquiring portion 116 determines that, for example, the object ‘the Museum of Kyoto’ that appears only in the map with a scale of 1/3000 has a more detailed scale relationship relative to the object ‘Chion-in Temple’ that appears in the maps with a scale of 1/3000 to 1/21000.

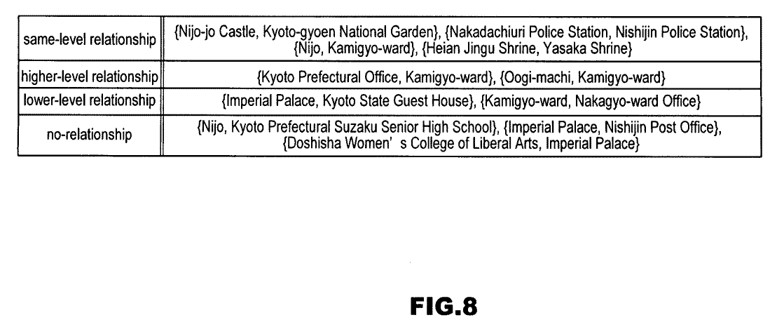

Then, the relationship information acquiring portion 116 acquires relationship information between two objects referring to FIG. 3, using the appearance pattern information and the region information of the geographical names (objects). The relationship information accumulating portion 117 accumulates the relationship information in the relationship information storage portion 112. For example, the relationship information management table shown in FIG. 8 is stored in the relationship information storage portion 112. In the relationship information management table shown in FIG. 8, ‘Kamigyo-ward’ has a higher-level relationship relative to ‘Kyoto Prefectural Office’. Furthermore, in the relationship information management table shown in FIG. 8, ‘Kyoto State Guest House’ has a lower-level relationship relative to ‘Imperial Palace’. Furthermore, in the relationship information management table shown in FIG. 8, objects paired with each other in the same-level relationship and the no-relationship are respectively object groups having the same-level relationship and object groups having the no-relationship.

Furthermore, the object selecting condition management table shown in FIG. 7 is held in the object selecting condition storage unit 1181. Records having the attribute values ‘ID’, ‘name of reconstruction function’, ‘object selecting condition’, ‘object selecting method’, and ‘display attribute’ are stored in the object selecting condition management table. ‘ID’ refers to an identifier identifying a record. ‘Name of reconstruction function’ refers to the name of a reconstruction function. The reconstruction function is a function to change the display status of an object on a map. Changing the display status is, for example, changing the display attribute value of an object, or changing display/non-display of an object. ‘Object selecting condition’ refers to a condition for selecting an object that is to be reconstructed. ‘Object selecting condition’ has ‘operation information sequence condition’, ‘operation chunk condition’, and ‘relationship information condition’. ‘Operation information sequence condition’ refers to a condition having an operation information sequence. The operation information sequence is, for example, information indicating an operation sequence of ‘c+i+[mc]+’ or ‘c+o+([mc]*c+i+)+’. Here, [mc]* refers to repeating ‘m’ or ‘c’ at least zero times. ‘Operation chunk condition’ refers to a condition for an operation chunk. The operation chunk is a meaningful combination of some operations. Accordingly, ‘operation chunk condition’ and ‘operation information sequence condition’ are the same if viewed from the map information processing apparatus 11. Herein, an operation using ‘operation information sequence condition’ without using ‘operation chunk condition’ will be described. As the operation chunk, for example, four types, namely, refinement chunk (N), wide-area search chunk (W), movement chunk (P), and position confirmation chunk (C) are conceivable. The operation information sequence of refinement chunk (N) is ‘c+i+’. The operation information sequence of wide-area search chunk (W) is ‘c+o+’. The operation information sequence of movement chunk (P) is ‘[mc]+’. The operation information sequence of position confirmation chunk (C) is ‘o+i+’. Furthermore, the refinement chunk is an operation sequence used in a case where the user becomes interested in a given point on a map and tries to view that point in more detail. The c operation is performed to obtain movement toward the interesting point, and then the i operation is performed in order to view the interesting point in more detail. The wide-area search chunk is an operation sequence used in a case where the user tries to view another point after becoming interested in a given point on a map. The c operation is performed to display a given point at the center, and then the o operation is performed to switch the map to a wide map. The movement chunk is an operation sequence to change the map display position in maps with the same scale. The movement chunk is used in a case where the user tries to move from a given point to search for another point. The position confirmation chunk is an operation sequence used in a case where the map scale is once switched to a wide scale in order to determine the positional relationship between the currently displayed point and another point, and then the map scale is returned to the original scale after the confirmation.

Next, it is assumed that the user inputs a map output instruction to the terminal apparatus 12. The terminal-side accepting portion 121 of the terminal apparatus 12 accepts the map output instruction. The terminal-side transmitting portion 122 transmits the map output instruction to the map information processing apparatus 11. Then, the accepting portion 113 of the map information processing apparatus 11 receives the map output instruction. The map output portion 114 reads map information corresponding to the map output instruction from the map information storage portion 111, and transmits a map to the terminal apparatus 12. The terminal-side receiving portion 123 of the terminal apparatus 12 receives the map. The terminal-side output portion 124 outputs the map. For example, it is assumed that a map of Kyoto is output to the terminal apparatus 12.

Hereinafter, specific examples of five reconstruction functions will be described.

### SPECIFIC EXAMPLE 1

Specific Example 1 is an example of a multiple-point search reconstruction function. It is assumed that, in a state where a map of Kyoto is output to the terminal apparatus 12, the user has performed the c operation (centering operation) on ‘Heian Jingu Shrine’, the o operation (zoom-out operation), and then the c operation on ‘Yasaka Shrine’ on the output map, for example, using an input unit such as a mouse or the finger (in the case of a touch panel).

Then, the terminal-side accepting portion 121 of the terminal apparatus 12 accepts this operation. Then, the terminal-side transmitting portion 122 transmits operation information corresponding to this operation, to the map information processing apparatus 11.

Next, the accepting portion 113 of the map information processing apparatus 11 receives the operation information sequence ‘coc’. The operation information sequence acquiring portion 115 acquires the operation information sequence ‘coc’, and arranges it in the memory. Typically, operation information is transmitted from the terminal apparatus 12 to the map information processing apparatus 11 each time one user operation is performed. However, in this example, a description of the operation of the map information processing apparatus 11 and the like for each operation has been omitted.

Next, the map output changing portion 119 reads map information corresponding to the map browse operation ‘coc’ from the map information storage portion 111, and arranges it in the memory. It should be noted that this technique is a known art. Furthermore, the objects ‘Heian Jingu Shrine’ and ‘Yasaka Shrine’ positioned at the center due to the c operation are selected and temporarily stored in the buffer.

Next, the display attribute determining portion 118 checks whether or not the operation information sequence ‘coc’ in the buffer matches any of the object selecting conditions in the object selecting condition management table in FIG. 7. The display attribute determining portion 118 judges that the operation information sequence matches the object selecting condition ‘c+o+[mc]+’ whose ID is 1, among the object selecting conditions in the object selecting condition management table in FIG. 7.

Next, the display attribute determining portion 118 acquires the relationship information condition ‘same-level’ in the object selecting condition management table in FIG. 7. The display attribute determining portion 118 judges whether or not the selected objects ‘Heian Jingu Shrine’ and ‘Yasaka Shrine’ stored in the buffer have the same-level relationship, using the relationship information management table in FIG. 8. Herein, the display attribute determining portion 118 judges that ‘Heian Jingu Shrine’ and ‘Yasaka Shrine’ have the same-level relationship. In the process described above, the display attribute determining portion 118 has judged that the accepted operation sequence matches the multiple-point search.

Next, the display attribute determining portion 118 acquires objects corresponding to the object selecting methods ‘selected object’, ‘same-level relationship’, and ‘the other objects’ of the record whose ID is 1 in the object selecting condition management table in FIG. 7. That is to say, the display attribute determining portion 118 acquires ‘Heian Jingu Shrine’ and ‘Yasaka Shrine’ corresponding to ‘selected object’, and stores them in the buffer. The display attribute determining portion 118 sets a display attribute of ‘Heian Jingu Shrine’ and ‘Yasaka Shrine’, to the display attribute corresponding to the display attribute ‘emphasize’ of the record whose ID is 1 (e.g., a character string is displayed in the BOLD font, the background of a text box is displayed in yellow, the background of a region is displayed in a dark color, etc.). ‘Selected object’ refers to one or more objects that are present at a position closest to the center point of the map in a case where one or more centering operations are performed in a series of operations. It is preferable that the display attribute determining portion 118 judges whether or not the selected object is present in the finally output map information, and sets the display attribute only in a case where the selected object is present.

Furthermore, the display attribute determining portion 118 selects objects having the same-level relationship relative to the selected object ‘Heian Jingu Shrine’ or ‘Yasaka Shrine’ from the relationship information management table in FIG. 8, using the object selecting method ‘same-level relationship’. The display attribute determining portion 118 selects same-level objects such as ‘Kodai-ji Temple’ and ‘Anyo-ji Temple’, and stores them in the buffer. The display attribute determining portion 118 sets a display attribute corresponding to the display attribute ‘emphasize’ also for the same-level objects such as ‘Kodai-ji Temple’ and ‘Anyo-ji Temple’. It is preferable that the display attribute determining portion 118 judges whether or not the same-level object is present in the finally output map information, and sets the display attribute only in a case where the same-level object is present.

Next, the display attribute determining portion 118 acquires objects corresponding to ‘the other objects’ (objects that are present in the finally output map information and that are neither the selected object nor the same-level object), and stores them in the buffer. This sort of object is, for example, ‘Hotel Ryozen’. Then, the display attribute determining portion 118 sets a display attribute of this sort of object, to the display attribute corresponding to the display attribute ‘deemphasize’ of the record whose ID is 1 (e.g., a character string is displayed in grey, the background of a region is made semitransparent, etc.).

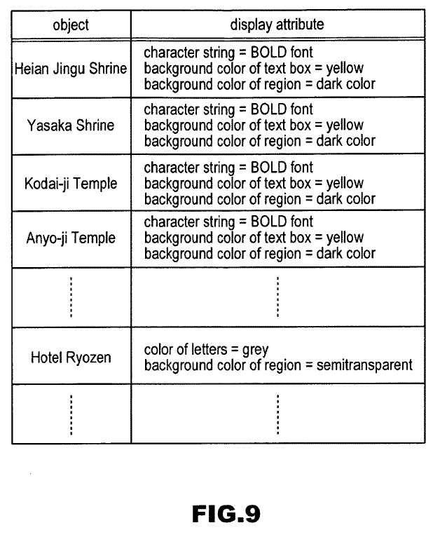

Then, the display attribute determining portion 118 obtains the object display attribute management table shown in FIG. 9 in the buffer. The object display attribute management table is temporarily used information.

Next, the map output changing portion 119 transmits the changed map information to the terminal apparatus 12. The changed map information is the map information containing the objects in the object display attribute management table shown in FIG. 9.

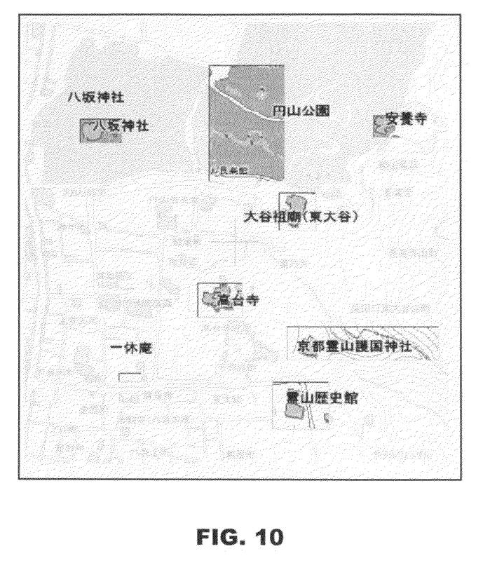

Next, the terminal apparatus 12 receives and outputs the map information. FIG. 10 shows this output image. In FIG. 10, the selected objects and the same-level objects are emphasized, and the other objects are deemphasized.

It will be appreciated that a map that is to be output is changed due to the first ‘c’ operation and the next ‘o’ operation in the operation information sequence ‘coc’. This means that, also in this case, the display attribute determining portion 118 checked whether or not the operation information sequence ‘c’ and the operation information sequence ‘co’ matched any of the object selecting conditions in the object selecting condition management table in FIG. 7, but the reconstruction function was not obtained because there was no matching object selecting condition. Note that the same is applied to Specific Examples 2 to 5.

The multiple-point search reconstruction function is a reconstruction function generated in a case where, when an operation to widen the search range from a given point to another wider region is performed, the selected geographical names have the same-level relationship. If this reconstruction function is generated, it seems that the user is searching for a display object similar to the point in which the user was previously interested. As the reconstruction effect, selected objects are emphasized, and objects having the same-level relationship relative to a geographical name on which the c operation has been performed are emphasized. With this effect, finding of similar points can be assisted. The trigger is the c operation, and this effect continues until the c operation is performed and selected objects are judged to have the same-level relationship. It is preferable that operation information functioning as the trigger is held in the display attribute determining portion 118 for each reconstruction function such as the multiple-point search reconstruction function, and that the display attribute determining portion 118 checks whether or not an operation information sequence matches the object selecting condition management table in FIG. 7 if operation information matches the trigger. Note that the same is applied to other specific examples.

### SPECIFIC EXAMPLE 2

Specific Example 2 is an example of an interesting-point refinement reconstruction function. It is assumed that, in this status, the user has performed a given operation (e.g., the c operation and the o operation), the c operation on ‘Heian Jingu Shrine’, and then the i operation in order to obtain detailed information on an output map of Kyoto, for example, using an input unit such as a mouse or the finger (in the case of a touch panel). That is to say, the accepting portion 113 of the map information processing apparatus 11 receives for example, the operation information sequence ‘coci’. Here, the operation of the terminal apparatus 12 has been omitted.

Then, the map output changing portion 119 reads map information corresponding to the map browse operation ‘coci’ from the map information storage portion 111, and arranges it in the memory.

Next, the display attribute determining portion 118 checks whether or not the operation information sequence ‘coci’ in the buffer matches any of the object selecting conditions in the object selecting condition management table in FIG. 7. It is assumed that the display attribute determining portion 118 judges that the operation information sequence matches the object selecting condition ‘c+o+([mc]*c+i+)+’ whose ID is 2, among the object selecting conditions in the object selecting condition management table in FIG. 7. Herein, the relationship information condition is not used.

Next, the display attribute determining portion 118 acquires objects corresponding to the object selecting methods ‘selected object’ and ‘newly displayed object’ of the record whose ID is 2 in the object selecting condition management table in FIG. 7. That is to say, the display attribute determining portion 118 acquires ‘Heian Jingu Shrine’ corresponding to ‘selected object’, and stores it in the buffer. Then, the display attribute determining portion 118 sets a display attribute of ‘Heian Jingu Shrine’, to the display attribute corresponding to the display attribute ‘emphasize’ of the record whose ID is 2.

Next, the map output changing portion 119 transmits the changed map information to the terminal apparatus 12. The changed map information is the map information containing the objects in the buffer.

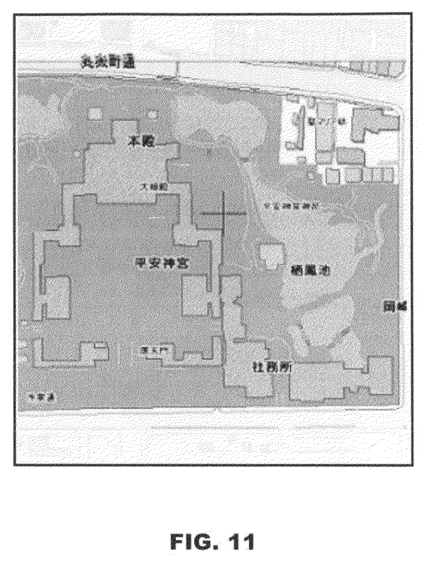

Next, the terminal apparatus 12 receives and outputs the map information. FIG. 11 shows this output image. In FIG. 11, selected objects such as ‘Heian Jingu Shrine’ are emphasized. That is to say, in FIG. 11, the geographical name and the region of Heian Jingu Shrine are emphasized, and objects that newly appear in this scale are also emphasized.

The interesting-point refinement reconstruction function is a reconstruction function generated in a case where, in a zoomed out state, the user is interested in a given point and performs the c operation, and then performs the i operation in order to obtain detailed information. The relationship between selected geographical names is not used. If this reconstruction function is generated, it seems that the user is refining points for some purpose. As the reconstruction effect, objects that newly appear due to the operation are emphasized, and selected objects are emphasized. It seems that finding of a destination point can be assisted by emphasizing newly displayed objects at the time of a refinement operation. In the interesting-point refinement reconstruction function, the trigger is the i operation, this effect does not continue, and the reconstruction is performed each time the i operation is performed.

### SPECIFIC EXAMPLE 3

Specific Example 3 is an example of a simple movement reconstruction function. It is assumed that, in this status, the user has input the move operation ‘m’ from a point near ‘Nishi-Hongwanji Temple’ toward ‘Kyoto Station’ on an output map of Kyoto, for example, using an input unit such as a mouse or the finger (in the case of a touch panel).

Then, the accepting portion 113 of the map information processing apparatus 11 receives the operation information sequence ‘m’.

Next, the map output changing portion 119 reads map information corresponding to the map browse operation ‘m’ from the map information storage portion 111, and arranges it in the memory.

It is assumed that the display attribute determining portion 118 is adding objects as being closest to the center point of the output map to the buffer. It is assumed that ‘Nishi-Hongwanji Temple’ and ‘Kyoto Station’ are currently stored in the buffer. The display attribute determining portion 118 may select, for example, objects on which an instruction is given from the user in the map operation, and add them in the buffer.

Next, the display attribute determining portion 118 checks whether or not the operation information sequence ‘m’ in the buffer matches any of the object selecting conditions in the object selecting condition management table in FIG. 7. The display attribute determining portion 118 judges that the operation information sequence matches the object selecting condition ‘[mc]+’ whose ID is 3 and 4, among the object selecting conditions in the object selecting condition management table in FIG. 7.

Next, the display attribute determining portion 118 acquires the relationship information condition ‘no-relationship’ and ‘same-level or higher-level or lower-level’ whose ID is 3 and 4, among the object selecting conditions in the object selecting condition management table in FIG. 7. The display attribute determining portion 118 judges that ‘Nishi-Hongwanji Temple’ and ‘Kyoto Station’ has ‘no-relationship’ based on the relationship information management table in FIG. 8. The display attribute determining portion 118 judges that the operation information sequence and the selected objects (herein, ‘Nishi-Hongwanji Temple’ and ‘Kyoto Station’) in the buffer match the object selecting condition whose ID is 3 in the object selecting condition management table in FIG. 7.

Next, the display attribute determining portion 118 acquires the object selecting method ‘already displayed object’ and the display attribute ‘deemphasize’, and the object selecting method ‘selected object’ and the display attribute ‘emphasize’ of the record whose ID is 3 in the object selecting condition management table in FIG. 7. The display attribute determining portion 118 acquires already displayed objects, which are objects that were most recently or previously displayed and that are contained in the currently read map information, and stores them in the buffer. Then, an attribute value (semitransparent, etc.) corresponding to ‘deemphasize’ is set as the display attribute of the stored objects. Furthermore, the selected objects (‘Nishi-Hongwanji Temple’ and ‘Kyoto Station’) are stored in the buffer. Then, an attribute value (BOLD font, etc.) corresponding to ‘emphasize’ is set as the display attribute of the stored objects.

Next, the map output changing portion 119 transmits the changed map information to the terminal apparatus 12. The changed map information is the map information containing the objects whose display attribute has been changed by the display attribute determining portion 118.

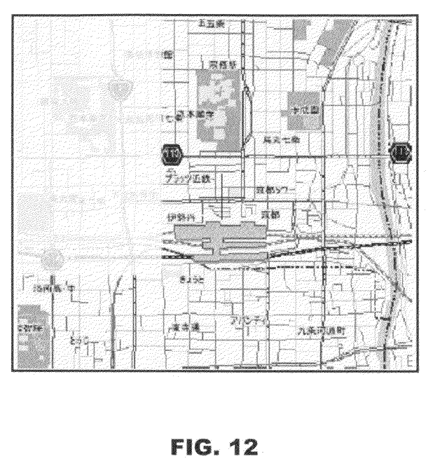

Next, the terminal apparatus 12 receives and outputs the map information. FIG. 12 shows this output image. In FIG. 12, already displayed objects are deemphasized, and selected objects are emphasized. FIG. 12 is an effect example in the case of movement from a point near Nishi-Hongwanji Temple toward Kyoto Station, and map regions displayed in previous operations are deemphasized.

The simple movement reconstruction function in Specific Example 3 is a reconstruction function generated in a case where the m operations are successively performed, but the selected geographical names do not have any relationship. That is to say, the simple movement reconstruction function is generated in a case where the relationship between geographical names is the no-relationship. If this simple movement reconstruction function is generated, it seems that the user still cannot find any interesting point, or does not know where he or she is. As the reconstruction effect, already displayed objects are deemphasized, and selected objects are emphasized. With the simple movement reconstruction function, displayed objects that have been already viewed are deemphasized, and the user can see which portions have been already viewed and which portions have not been confirmed yet. The trigger is the m or c operation, and the effect continues while the operation continues.

### SPECIFIC EXAMPLE 4

Specific Example 4 is an example of a selection movement reconstruction function. The selection movement reconstruction function is a reconstruction function generated in a case where geographical names selected by the display attribute determining portion 118 and stored in the buffer while the m operation is performed have the same-level, higher-level, or lower-level relationship (see the object selecting condition management table in FIG. 7). If this reconstruction function is generated, it seems that the user is interested in something, and selectively moves between these geographical names on purpose. As the reconstruction effect, already displayed objects are deemphasized, selected objects are emphasized, and objects are emphasized depending on the relationship between geographical names. It seems that in addition to deemphasizing regions that have been already viewed, presenting displayed objects according to the relationship between geographical names makes it possible to show candidates for objects that the user wants to view next. The trigger is the m or c operation, and the effect continues while the operation continues.

### SPECIFIC EXAMPLE 5

Specific Example 5 is an example of a position confirmation reconstruction function. It is assumed that, in this status, the user has performed the c operation on ‘Higashi-Honganji Temple’, the c operations on ‘Platz Kintetsu Department Store’, ‘Kyoto Tower’, and ‘Isetan Department Store’ while moving between them, the o operation, and then the i operation on an output map of Kyoto, for example, using an input unit such as a mouse or the finger (in the case of a touch panel).

Then, the accepting portion 113 of the map information processing apparatus 11 successively receives the operation information sequence ‘cmcmcmcoi’.

Next, the map output changing portion 119 reads map information corresponding to the operation information sequence ‘cmcmcmcoi’ from the map information storage portion 111, and arranges it in the memory.

It is assumed that the display attribute determining portion 118 accumulates the objects ‘Higashi-Honganji Temple’, ‘Platz Kintetsu Department Store’, ‘Kyoto Tower’, and ‘Isetan Department Store’ corresponding to the c operations in the buffer. This buffer is a buffer in which selected objects are stored.

Next, the display attribute determining portion 118 checks whether or not the operation information sequence ‘cmcmcmcoi’ in the buffer matches any of the object selecting conditions in the object selecting condition management table in FIG. 7. It is assumed that the display attribute determining portion 118 judges that the operation information sequence matches the object selecting condition whose ID is 5, among the object selecting conditions in the object selecting condition management table in FIG. 7.

Next, the display attribute determining portion 118 acquires the object selecting method ‘previously selected region’ and the display attribute ‘emphasize’, and the object selecting method ‘group of selected objects’ and the display attribute ‘output and emphasize’ of the record whose ID is 5 in the object selecting condition management table in FIG. 7.

Then, the display attribute determining portion 118 sets a display attribute of previously selected objects, to a display attribute in which regions corresponding to the objects are emphasized (e.g., background is displayed in a dark color, etc.). Furthermore, the selected objects ‘Higashi-Honganji Temple’, ‘Platz Kintetsu Department Store’, ‘Kyoto Tower’, and ‘Isetan Department Store’ are output without fail (even in a case where the selected objects are not present in the map information), and the display attribute at the time of output is set to an attribute value (e.g., BOLD font, etc.) corresponding to ‘emphasize’.

Next, the map output changing portion 119 transmits the changed map information to the terminal apparatus 12. The changed map information is the map information containing the objects whose display attribute has been changed by the display attribute determining portion 118.

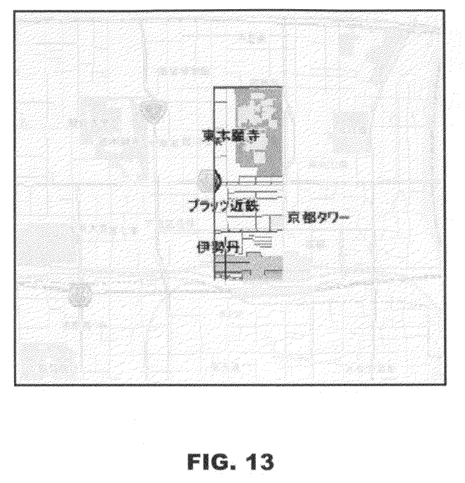

Next, the terminal apparatus 12 receives and outputs the map information. FIG. 13 shows this output image. In FIG. 13, a rectangle containing four points (‘Higashi-Honganji Temple’, ‘Platz Kintetsu Department Store’, ‘Kyoto Tower’, and ‘Isetan Department Store’) emphasized in the c operations is emphasized.

The position confirmation reconstruction function is a reconstruction function generated in a case where the o operation is performed after the m operation. Since all geographical names on which the c operation is performed have to be presented, the relationship between geographical names is not used. If this reconstruction function is generated, it seems that the user is trying to confirm the current position in a map wider than the current map, for example, because the user has lost his or her position in the m operations or wants to confirm how the points have been checked. As the reconstruction effect, portions between selected regions are emphasized, and deleted geographical names are displayed again. The selected region refers to a displayed object emphasized in the c operation or the like performed before the reconstruction function is generated. The minimum rectangular region including all select regions is emphasized. Furthermore, since a selected geographical name may be deleted when controlling the level of detail at the time of the o operation, geographical names on which the centering operation has been performed are displayed without fail. With this effect, it is possible to present information almost the same as a route formed by the position currently viewed by the user and the positions between which the user previously moved.

As described above, with this embodiment, a map according to a purpose of the user can be output. More specifically, with this embodiment, a display attribute of an object (a geographical name, an image, etc.) on a map can be changed according to a map browse operation sequence, which is a group of one or at least two map browse operations.

Furthermore, with this embodiment, the display attribute of an object is changed using the map browse operation sequence and the relationship information between objects, and thus a map on which a purpose of the user is reflected more precisely can be output.

Furthermore, with this embodiment, the relationship information between objects can be automatically acquired, and thus a map on which a purpose of the user is reflected can be easily output.

In this embodiment, the map information processing apparatus 11 may be a stand-alone apparatus. Furthermore, the map information processing apparatus 11, or the map information processing apparatus 11 and the terminal apparatuses 12 may be one apparatus or one function of a navigation system installed on a moving object such as a vehicle. In this case, the operation information sequence may be an event generated by the travel of the moving object (movement to one or more points, or stopping at one or more points, etc.). Furthermore, the operation information sequence may be one or more pieces of operation information generated by an event generated by the travel of a moving object and a user operation.

Furthermore, with this embodiment, in a case where the map information processing apparatus 11 is installed on a moving object such as a vehicle, the map browse operation can be automatically generated by the travel of the moving object, as described above.

In this embodiment, the five examples were described as examples of the reconstruction functions. However, it will be appreciated that other examples of the reconstruction functions are also conceivable.

The process in this embodiment may be realized by software. The software may be distributed by software downloading or the like. The software may be distributed in the form where the software is stored in a storage medium such as a CD-ROM. Furthermore, it will be appreciated that this software or a storage medium in which this software is stored may be distributed as a computer program product. Note that the same is applied to other embodiments described in this specification. The software that realizes the map information processing apparatus in this embodiment may be a following program. Specifically, this program is a program for causing a computer to function as: an accepting portion that accepts a map output instruction, which is an instruction to output a map, and a map browse operation sequence, which is one or at least two operations to browse the map; a map output portion that reads map information from a storage medium and outputs the map in a case where the accepting portion accepts the map output instruction; an operation information sequence acquiring portion that acquires an operation information sequence, which is information of one or at least two operations corresponding to the map browse operation sequence accepted by the accepting portion; a display attribute determining portion that selects at least one object and determines a display attribute of the at least one object in a case where the operation information sequence matches an object selecting condition, which is a predetermined condition for selecting an object; and a map output changing portion that acquires map information corresponding to the map browse operation, and outputs map information having the at least one object according to the display attribute of the at least one object determined by the display attribute determining portion.

Furthermore, in this program, it is preferable that the display attribute determining portion selects at least one object and determines a display attribute of the at least one object using the operation information sequence and relationship information between at least two objects.

Furthermore, in this program, it is preferable that multiple pieces of map information of the same region with different scales are stored in a storage medium, and the computer is caused to further function as a relationship information acquiring portion that acquires relationship information between at least two objects using an appearance pattern of the at least two objects in the multiple pieces of map information with different scales and positional information of the at least two objects.

### Embodiment 2

In this embodiment, a map information processing system will be described in which a search formula (also may be only a keyword) for searching for information is constructed using input from the user or output information (e.g., a web page, etc.) and a map browse operation leading to browse of a map, and information is retrieved using the search formula and output. Also, a navigation system will be described on which the function of this map information processing system is installed and in which information is output at a terminal that can be viewed by the driver only when the vehicle is stopping, and information is output only at terminals of the assistant driver's seat or the rear seats when the vehicle is traveling.

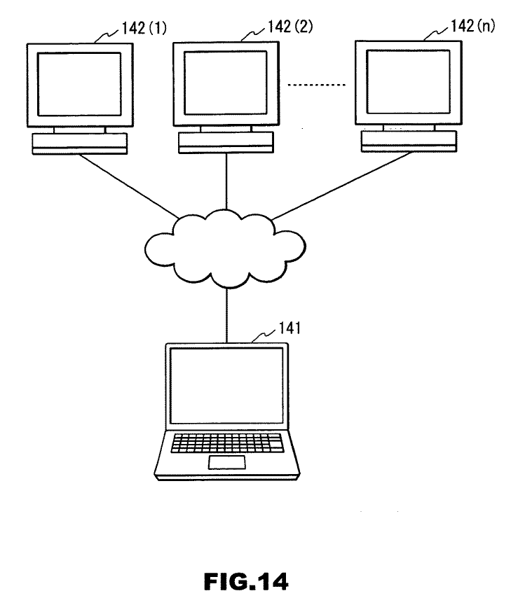

FIG. 14 is a conceptual diagram of a map information processing system in this embodiment. The map information processing system has a map information processing apparatus 141 and one or more information storage apparatuses 142. The map information processing system may have one or more terminal apparatuses 12.

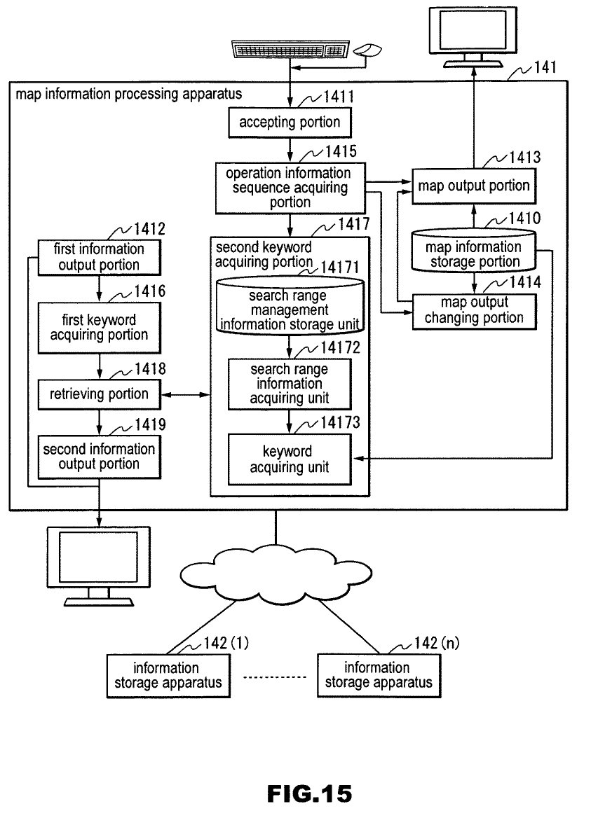

FIG. 15 is a block diagram of a map information processing system 2 in this embodiment. The map information processing apparatus 141 includes a map information storage portion 1410, an accepting portion 1411, a first information output portion 1412, a map output portion 1413, a map output changing portion 1414, an operation information sequence acquiring portion 1415, a first keyword acquiring portion 1416, a second keyword acquiring portion 1417, a retrieving portion 1418, and a second information output portion 1419.

The second keyword acquiring portion 1417 includes a search range management information storage unit 14171, a search range information acquiring unit 14172, and a keyword acquiring unit 14173.

In the information storage apparatuses 142, information that can be retrieved by the map information processing apparatus 141 is stored. The information storage apparatuses 142 read information according to a request from the map information processing apparatus 141, and transmit the information to the map information processing apparatus 141. The information is, for example, web pages, records stored in databases, or the like. There is no limitation on the data type (a character string, a still image, a moving image, a sound, etc.) and the data format. Furthermore, the information may be, for example, advertisements, the map information, or the like. The information storage apparatuses 142 are web servers holding web pages, database servers including databases, or the like.

In the map information storage portion 1410, map information, which is information of a map, can be stored. The map information in the map information storage portion 1410 may be information acquired from another apparatus, or may be information stored in advance in the map information processing apparatus 141. The map information has, for example, map image information indicating an image of the map, and term information having a term and positional information indicating the position of the term on the map. The map image information is, for example, bitmap or vector data constituting a map. The term has a character string of, for example, a geographical name, a building name, a name of scenic beauty, or a location name, or the like indicated on the map. Furthermore, the positional information is information having the longitude and the latitude on a map, XY coordinate values on a two-dimensional plane. Furthermore, the map information also may be an ISO kiwi map data format. Furthermore, the map information preferably has the map image information and the term information for each scale. The map information storage portion 1410 is preferably a non-volatile storage medium, but can be realized also as a volatile storage medium.

The accepting portion 1411 accepts various instructions and operations from the user. The various instructions and operations are, for example, an instruction to output the map, a map browse operation, which is an operation to browse the map, or the like. The map browse operation is a zoom-in operation (hereinafter, the zoom-in operation may be indicated as the symbol [i]), a zoom-out operation (hereinafter, the zoom-out operation may be indicated as the symbol [o]), a move operation (hereinafter, the move operation may be indicated as the symbol [m]), a centering operation (hereinafter, the centering operation may be indicated as the symbol [c]), and the like. Furthermore, multiple map browse operations are collectively referred to as a map browse operation sequence. The various instructions are a first information output instruction, which is an instruction to output first information, a map output instruction to output a map, and the like. The first information is, for example, web pages, map information, and the like. For example, the first information may be advertisements or the like, or may be information output together with a map. The first information output instruction includes, for example, one or more search keywords, a URL, and the like. There is no limitation on the input unit of the various instructions and operations, and it is possible to use a keyboard, a mouse, a menu screen, a touch panel, and the like. The accepting portion 1411 may be realized as a device driver of an input unit such as a mouse, control software for a menu screen, or the like.

The first information output portion 1412 outputs first information according to the first information output instruction accepted by the accepting portion 1411. The first information output portion 1412 may be realized, for example, as a search engine, a web browser, and the like. The first information output portion 1412 may perform only a process of passing a keyword contained in the first information output instruction to a so-called search engine. Here, ‘output’ has a concept that includes, for example, output to a display, projection using a projector, printing in a printer, outputting a sound, transmission to an external apparatus, accumulation in a storage medium, and delivery of a processing result to another processing apparatus or another program. The first information output portion 1412 may be considered to include, or to not include, an output device such as a display or a loudspeaker. The first information output portion 1412 may be realized, for example, as driver software for an output device, or a combination of driver software for an output device and the output device.

If the accepting portion 1411 accepts an instruction to output the map, the map output portion 1413 reads the map information from the map information storage portion 1410 and outputs the map. It will be appreciated that the map output portion 1413 may read and output only the map image information. Here, ‘output’ has a concept that includes, for example, output to a display, printing in a printer, outputting a sound, and transmission to an external apparatus. The map output portion 1413 may be considered to include, or to not include, an output device such as a display or a loudspeaker. The map output portion 1413 may be realized, for example, as driver software for an output device, or a combination of driver software for an output device and the output device.

If the accepting portion 1411 accepts a map browse operation, the map output changing portion 1414 changes output of the map according to the map browse operation. Here, ‘to change output of the map’ also refers to a state in which an instruction to change output of the map is given to the map output portion 1413.

More specifically, if the accepting portion 1411 accepts a zoom-in operation, the map output changing portion 1414 zooms in on the map that has been output. If the accepting portion 1411 accepts a zoom-out operation, the map output changing portion 1414 zooms out from the map that has been output. Furthermore, if the accepting portion 1411 accepts a move operation, the map output changing portion 1414 moves the map that has been output, according to the operation. Moreover, if the accepting portion 1411 accepts a centering operation, the map output changing portion 1414 moves the screen so that a point indicated by an instruction on the map that has been output is positioned at the center of the screen. The process performed by the map output changing portion 1414 is a known art, and thus a detailed description thereof has been omitted. The map output changing portion 1414 may perform a process of writing information designating the map after the change (e.g., the scale of the map, and the positional information of the center point of the map that has been output, etc.) to a buffer. Here, the information designating the map after the change is referred to as ‘output map designating information’ as appropriate.

The map output changing portion 1414 can be realized typically as an MPU, a memory, or the like. Typically, the processing procedure of the map output changing portion 1414 is realized by software, and the software is stored in a storage medium such as a ROM. Note that the processing procedure also may be realized by hardware (dedicated circuit).

The operation information sequence acquiring portion 1415 acquires an operation information sequence, which is information of operations corresponding to the map browse operation sequence. The operation information sequence acquiring portion 1415 acquires an operation information sequence, which is a series of two or more pieces of operation information, and ends one automatically acquired operation information sequence if a given condition is matched. The operation information sequence is, for example, as follows. First, as an example of the operation information sequence, there is a single-point specifying operation information sequence, which is information indicating the operation sequence ‘m*c+i+’, and is an operation information sequence specifying one given point. Furthermore, as an example of the operation information sequence, there is a multiple-point specifying operation information sequence, which is information indicating the operation sequence ‘m+o+’, and is an operation information sequence specifying two or more given points. Furthermore, as an example of the operation information sequence, there is a selection specifying operation information sequence, which is information indicating the operation sequence ‘i+c[c*m*]*’, and is an operation information sequence sequentially selecting multiple points. Furthermore, as an example of the operation information sequence, there is a surrounding-area specifying operation information sequence, which is information indicating the operation sequence ‘c+m*o+’, and is an operation information sequence checking the positional relationship between multiple points. Furthermore, as an example of the operation information sequence, there is a wide-area specifying operation information sequence, which is information indicating the operation sequence ‘o+m+’, and is an operation information sequence causing movement along multiple points. Moreover, there are operation sequences in which one or more of the five types of operation information sequences (the single-point specifying operation information sequence, the multiple-point specifying operation information sequence, the selection specifying operation information sequence, the surrounding-area specifying operation information sequence, and the wide-area specifying operation information sequence) are combined.

Examples of the combination of the above-described five types of operation information sequences include a refinement search operation information sequence, a comparison search operation information sequence, and a route search operation information sequence, which are described below. The refinement search operation information sequence is an operation information sequence in which a single-point specifying operation information sequence is followed by a single-point specifying operation information sequence, and then the latter single-point specifying operation information sequence is followed by and partially overlapped with a selection specifying operation information sequence. The comparison search operation information sequence is an operation information sequence in which a selection specifying operation information sequence is followed by a multiple-point specifying operation information sequence, and then the multiple-point specifying operation information sequence is followed by and partially overlapped with a wide-area specifying operation information sequence. The route search operation information sequence is an operation information sequence in which a surrounding-area specifying operation information sequence is followed by a selection specifying operation information sequence.

Furthermore, examples of the given condition indicating a break of one operation information sequence described above include a situation in which a movement distance in the move operation is larger than a predetermined threshold value. Examples of the given condition further include a situation in which the accepting portion 1411 has not accepted an operation for a certain period of time. Examples of the given condition further include a situation in which the accepting portion 1411 has accepted an instruction from the user to end the map operation (including an instruction to turn the power off.

Furthermore, the operation information sequence is preferably information constituted by a combination of information acquired in a map operation of the user and information generated by the travel of a moving object such as a vehicle. The information generated by the travel of a moving object such as a vehicle is, for example, information of the move operation [m] to a given point generated when the vehicle passes through the point, or information of the centering operation [c] to a given point generated when the vehicle is stopped at the point.

The operation information sequence acquiring portion 1415 can be realized typically as an MPU, a memory, or the like. Typically, the processing procedure of the operation information sequence acquiring portion 1415 is realized by software, and the software is stored in a storage medium such as a ROM. Note that the processing procedure also may be realized by hardware (dedicated circuit).

The first keyword acquiring portion 1416 acquires a keyword contained in the first information output instruction, or a keyword corresponding to the first information. The keyword corresponding to the first information is one or more terms or the like contained in the first information. If the first information is, for example, a web page, the keyword corresponding to the first information is one or more nouns in the title of the web page, a term indicating the theme of the web page, or the like. The term indicating the theme of the web page is, for example, a term that appears most frequently, a term that appears frequently in that web page and not frequently in other web pages (determined using, for example, tf/idf), or the like. Furthermore, the keyword contained in the first information output instruction is, for example, a term input by the user for searching for the web page. The first keyword acquiring portion 1416 can be realized typically as an MPU, a memory, or the like. Typically, the processing procedure of the first keyword acquiring portion 1416 is realized by software, and the software is stored in a storage medium such as a ROM. Note that the processing procedure also may be realized by hardware (dedicated circuit).

The second keyword acquiring portion 1417 acquires one or more keywords from the map information using the operation information sequence. The second keyword acquiring portion 1417 acquires one or more keywords from the map information in the map information storage portion 1410, using the one operation information sequence acquired by the operation information sequence acquiring portion 1415. The second keyword acquiring portion 1417 typically acquires a term from the term information contained in the map information. A term is synonymous with a keyword. An example of an algorithm for acquiring a keyword from an operation information sequence will be described later in detail. Here, ‘to acquire a keyword’ typically refers to a state in which a character string is simply acquired, but also may refer to a state in which a map image is recognized as characters and a character string is acquired. The second keyword acquiring portion 1417 can be realized typically as an MPU, a memory, or the like. Typically, the processing procedure of the second keyword acquiring portion 1417 is realized by software, and the software is stored in a storage medium such as a ROM. Note that the processing procedure also may be realized by hardware (dedicated circuit).

In the search range management information storage unit 14171, two or more pieces of search range management information are stored, each of which is a pair of an operation information sequence and search range information, the operation information sequence being two or more pieces of operation information, and the search range information being information of a map range of a keyword that is to be acquired. The search range information also may be information designating a keyword that is to be acquired, or may be information indicating a method for acquiring a keyword. The search range management information is, for example, information that has a refinement search operation information sequence and refinement search target information as a pair, the refinement search target information being information to the effect that a keyword of a destination point is acquired that is a point near (as being closest to, or within a given range from) the center point of the map output in a centering operation accepted after a zoom-in operation or in a move operation accepted after a zoom-in operation. The search range management information is, for example, information that has a comparison search operation information sequence and comparison search target information as a pair, the comparison search target information being information indicating a region representing a difference between the region of the map output after a zoom-out operation and the region of the map output before the zoom-out operation. The search range management information is, for example, information that has a comparison search operation information sequence and comparison search target information as a pair, the comparison search target information being information indicating a region obtained by excluding the region of the map output before a move operation from the region of the map output after the move operation. The search range management information is, for example, information that has a route search operation information sequence and route search target information as a pair, the route search target information being information to the effect that a keyword of a destination point is acquired that is a point near the center point of the map output in an accepted zoom-in operation or zoom-out operation. Moreover, the refinement search target information is information to the effect that a keyword of a destination point is acquired that is a point near the center point of the map output in a centering operation accepted after a zoom-in operation or in a move operation accepted after a zoom-in operation. The refinement search target information also may include information to the effect that a keyword of a mark point indicating a geographical name is acquired in the map output in a centering operation accepted before the zoom-in operation. Here, the destination point refers to a point that the user wants to look for on the map. The mark point refers to a point that functions as a mark used for reaching the destination point. Here, a point near a given point is a point as being closest to the point, a point as being within a given range from the point, or the like.

The search range management information storage unit 14171 is preferably a non-volatile storage medium, but can be realized also as a volatile storage medium.

The search range information acquiring unit 14172 acquires search range information corresponding to the operation information sequence that is one or more pieces of operation information acquired by the operation information sequence acquiring portion 1415, from the search range management information storage unit 14171. More specifically, if it is judged that the operation information sequence that is one or more pieces of operation information acquired by the operation information sequence acquiring portion 1415 corresponds to the refinement search operation information sequence, the search range information acquiring unit 14172 acquires the refinement search target information. Furthermore, if it is judged that the operation information sequence that is one or more pieces of operation information acquired by the operation information sequence acquiring portion 1415 corresponds to the comparison search operation information sequence, the search range information acquiring unit 14172 acquires the comparison search target information. Moreover, if it is judged that the operation information sequence that is one or more pieces of operation information acquired by the operation information sequence acquiring portion 1415 corresponds to the route search operation information sequence, the search range information acquiring unit 14172 acquires the route search target information. If the search range information acquiring unit 14172 is realized, for example, by software, the refinement search target information also may be a name of a function performing a refinement search. Similarly, the comparison search target information also may be a name of a function performing a comparison search. Similarly, the route search target information also may be a name of a function performing a route search.

The search range information acquiring unit 14172 can be realized typically as an MPU, a memory, or the like. Typically, the processing procedure of the search range information acquiring unit 14172 is realized by software, and the software is stored in a storage medium such as a ROM. Note that the processing procedure also may be realized by hardware (dedicated circuit).

The keyword acquiring unit 14173 acquires one or more keywords from the map information, according to the search range information acquired by the search range information acquiring unit 14172. The keyword acquiring unit 14173 acquires at least a keyword of a destination point corresponding to the refinement search target information acquired by the search range information acquiring unit 14172. The keyword acquiring unit 14173 also acquires a geographical name that is a keyword of a mark point corresponding to the refinement search target information acquired by the search range information acquiring unit 14172. The keyword acquiring unit 14173 acquires at least a keyword corresponding to the comparison search target information acquired by the search range information acquiring unit 14172. The keyword acquiring unit 14173 acquires at least a keyword of a destination point corresponding to the route search target information acquired by the search range information acquiring unit 14172. The keyword acquiring unit 14173 also acquires a geographical name that is a keyword of a mark point corresponding to the route search target information acquired by the search range information acquiring unit 14172. A specific example of the keyword acquiring process performed by the keyword acquiring unit 14173 will be described later in detail. Furthermore, the keyword of the destination point refers to a keyword with which the destination point can be designated. The keyword of the mark point refers to a keyword with which the mark point can be designated.

The keyword acquiring unit 14173 can be realized typically as an MPU, a memory, or the like. Typically, the processing procedure of the keyword acquiring unit 14173 is realized by software, and the software is stored in a storage medium such as a ROM. Note that the processing procedure also may be realized by hardware (dedicated circuit).

The retrieving portion 1418 retrieves information using two or more keywords acquired by the first keyword acquiring portion 1416 and the second keyword acquiring portion 1417. Here, it is preferable that the information is a web page on the Internet. Furthermore, the information also may be information within a database or the like. It will be appreciated that the information also may be the map information, advertising information, or the like. It is preferable that, for example, if the accepting portion 1411 accepts a refinement search operation information sequence, the retrieving portion 1418 retrieves a web page that has the keyword acquired by the first keyword acquiring portion 1416 in its page, that has the keyword of the destination point in its title, and that has the keyword of the mark point in its page. It is preferable that the retrieving portion 1418 acquires one or more web pages that contain the keyword acquired by the first keyword acquiring portion 1416, the keyword of the destination point, and the keyword of the mark point, detects two or more terms from each of the one or more web pages that have been acquired, acquires two or more pieces of positional information indicating the positions of the two or more terms from the map information, acquires geographical range information, which is information indicating a geographical range of a description of a web page, for each web page, using the two or more pieces of positional information, and acquires at least a web page in which the geographical range information indicates the smallest geographical range. It is preferable that if one or more web pages that contain the keyword acquired by the first keyword acquiring portion 1416, the keyword of the destination point, and the keyword of the mark point are acquired, the retrieving portion 1418 acquires one or more web pages that have at least one of the keywords in its title. For example, the retrieving portion 1418 may acquire a web page, or may pass a keyword to a so-called web search engine, start the web search engine, and accept a search result of the web search engine.

The retrieving portion 1418 can be realized typically as an MPU, a memory, or the like. Typically, the processing procedure of the retrieving portion 1418 is realized by software, and the software is stored in a storage medium such as a ROM. Note that the processing procedure also may be realized by hardware (dedicated circuit).

The second information output portion 1419 outputs the information retrieved by the retrieving portion 1418. Here, ‘output’ has a concept that includes, for example, output to a display, printing in a printer, outputting a sound, transmission to an external apparatus, and accumulation in a storage medium. The second information output portion 1419 may be considered to include, or to not include, an output device such as a display or a loudspeaker. The second information output portion 1419 may be realized, for example, as driver software for an output device, or a combination of driver software for an output device and the output device.

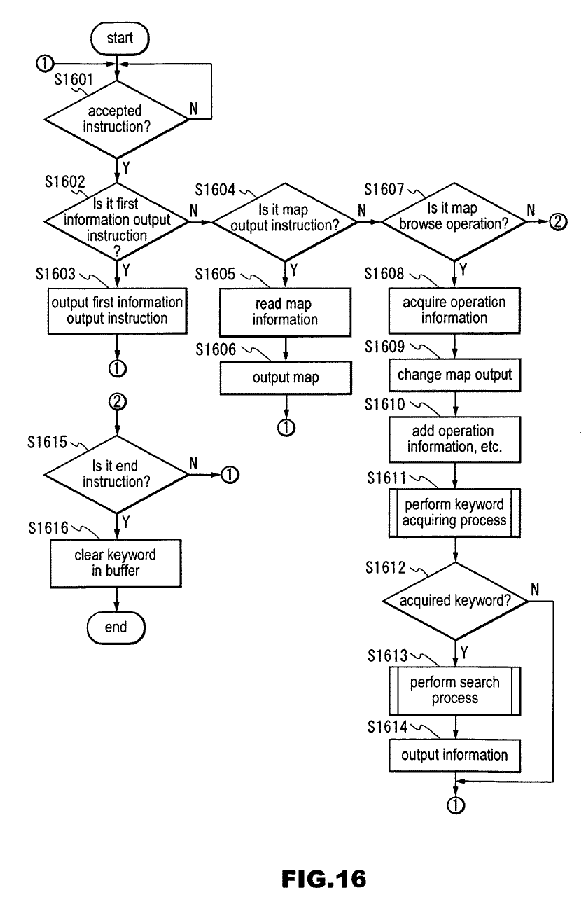

Next, the operation of the map information processing apparatus 141 will be described with reference to the flowcharts in FIGS. 16 to 21.

(Step S1601) The accepting portion 1411 judges whether or not an instruction is accepted from the user. If an instruction is accepted, the procedure proceeds to step S1602. If an instruction is not accepted, the procedure returns to step S1601.

(Step S1602) The first information output portion 1412 judges whether or not the instruction accepted in step S1601 is a first information output instruction. If the instruction is a first information output instruction, the procedure proceeds to step S1603. If the instruction is not a first information output instruction, the procedure proceeds to step S1604.

(Step S1603) The first information output portion 1412 outputs first information according to the first information output instruction accepted by the accepting portion 1411. For example, the first information output portion 1412 retrieves a web page using a keyword contained in the first information output instruction, and outputs the web page. The procedure returns to step S1601. The first information output portion 1412 may store one or more keywords contained in the first information output instruction or the first information in a predetermined buffer.

(Step S1604) The map output portion 1413 judges whether or not the instruction accepted in step S1601 is a map output instruction. If the instruction is a map output instruction, the procedure proceeds to step S1605. If the instruction is not a map output instruction, the procedure proceeds to step S1607.

(Step S1605) The map output portion 1413 reads map information from the map information storage portion 1410.

(Step S1606) The map output portion 1413 outputs a map using the map information read in step S1605. The procedure returns to step S1601.

(Step S1607) The map output portion 1413 judges whether or not the instruction accepted in step S1601 is a map browse operation. If the instruction is a map browse operation of the map, the procedure proceeds to step S1608. If the instruction is not a map browse operation of the map, the procedure proceeds to step S1615.

(Step S1608) The operation information sequence acquiring portion 1415 acquires operation information corresponding to the map browse operation accepted in step S1601.

(Step S1609) The map output changing portion 1414 changes output of the map according to the map browse operation.

(Step S1610) The map output changing portion 1414 stores the operation information acquired in step S1609 and output map designating information that is information designating the map output in step S1609, as a pair in a buffer. The output map designating information has, for example, a scale ID, which is an ID indicating the scale of the map, and positional information indicating the center point of the output map (e.g., having information of the longitude and the latitude). The output map designating information also may be a scale ID, and positional information at the upper left and positional information at the lower right of a rectangle of the output map. Here, the map output changing portion 1414 may store the operation information and the output map designating information as a pair in a buffer. For example, the output map designating information may be information designating the scale of the map and positional information of the center point of the output map, or may be bitmap of the output map and positional information of the center point of the output map.

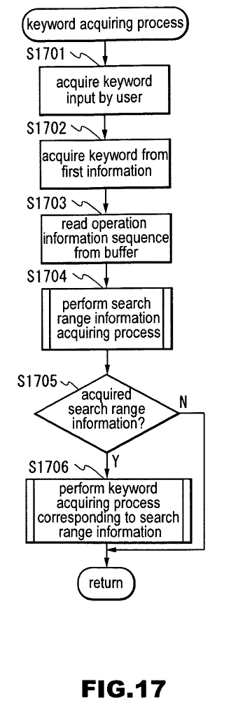

(Step S1611) The first keyword acquiring portion 1416 and the second keyword acquiring portion 1417 perform a keyword acquiring process. The keyword acquiring process will be described in detail with reference to the flowchart in FIG. 17.

(Step S1612) The retrieving portion 1418 judges whether or not a keyword has been acquired in step S1611. If a keyword has been acquired, the procedure proceeds to step S1613. If a keyword has not been acquired, the procedure returns to step S1601.

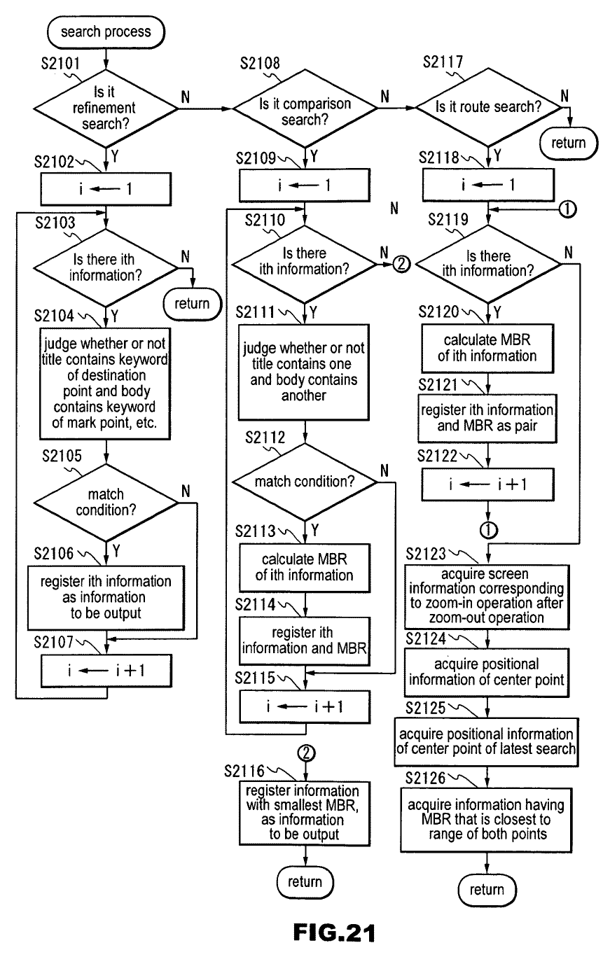

(Step S1613) The retrieving portion 1418 searches the information storage apparatuses 142 for information, using the keyword acquired in step S1611. An example of this search process will be described in detail with reference to the flowchart in FIG. 21.

(Step S1614) The second information output portion 1419 outputs the information searched for in step S1613. The procedure returns to step S1601.

(Step S1615) The map output portion 1413 judges whether or not the instruction accepted in step S1601 is an end instruction to end the process. If the instruction is an end instruction, the procedure proceeds to step S1616. If the instruction is not an end instruction, the procedure proceeds to step S1601.

(Step S1616) The map information processing apparatus 141 clears information such as keywords and operation information within the buffer. The process ends. The procedure returns to step S1601.

Note that the process is ended by powering off or interruption for aborting the process in the flowchart in FIG. 16.

Next, the keyword acquiring process in step S1611 will be described with reference to the flowchart in FIG. 17.

(Step S1701) The first keyword acquiring portion 1416 acquires a keyword input by the user. The keyword input by the user is, for example, a keyword contained in the first information output instruction accepted by the accepting portion 1411.

(Step S1702) The first keyword acquiring portion 1416 acquires a keyword from the first information (e.g., a web page) output by the first information output portion 1412.

(Step S1703) The search range information acquiring unit 14172 reads the operation information sequence, from a buffer in which the operation information sequences are stored.

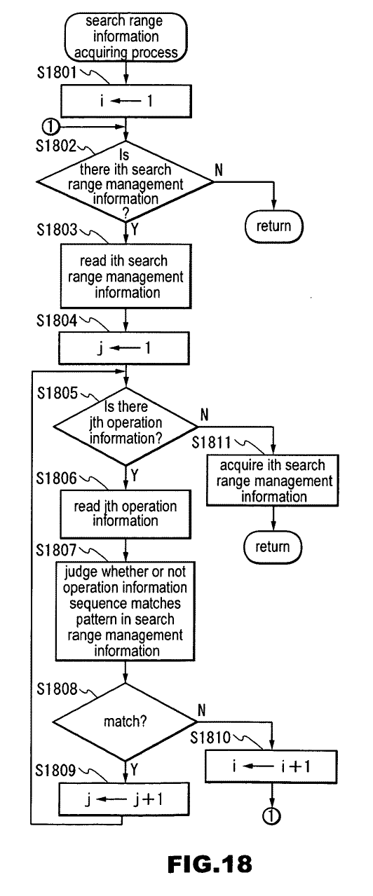

(Step S1704) The search range information acquiring unit 14172 performs a search range information acquiring process, which is a process of acquiring search range information, using the operation information sequence read in step S1703. The search range information acquiring process will be described with reference to the flowchart in FIG. 18.

(Step S1705) The keyword acquiring unit 14173 judges whether or not search range information has been acquired in step S1704. If search range information has been acquired, the procedure proceeds to step S1706. If search range information has not been acquired, the procedure returns to the upper-level function.

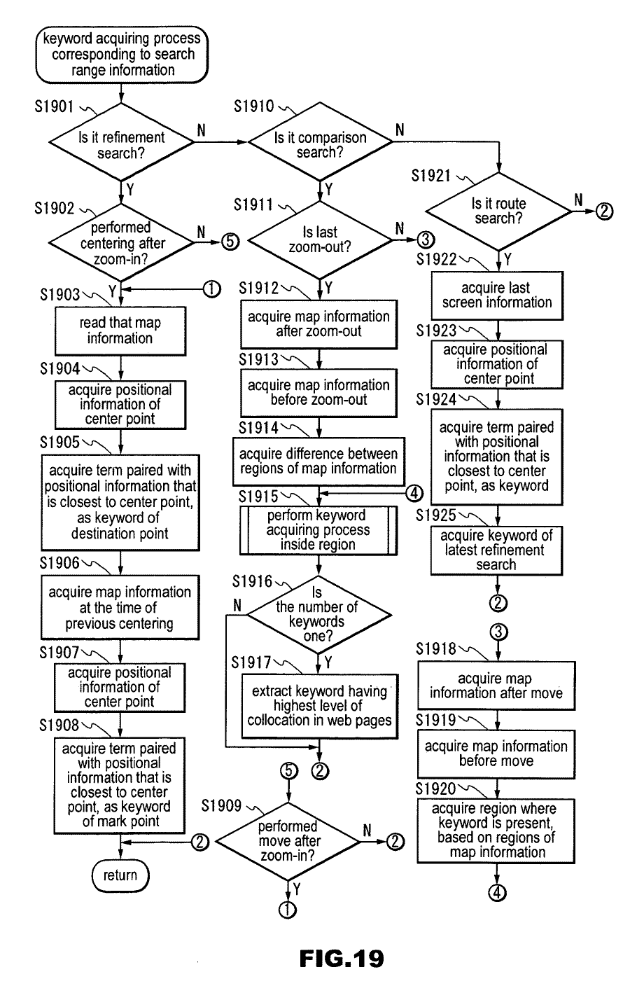

(Step S1706) The keyword acquiring unit 14173 performs a keyword acquiring process using the search range information acquired in step S1704. This keyword acquiring process will be described with reference to the flowchart in FIG. 19. The procedure returns to the upper-level function.

In the flowchart in FIG. 17, the first keyword acquiring portion 1416 acquires a keyword with the operation in step S1701 and the operation in step S1702. However, the first keyword acquiring portion 1416 may acquire a keyword with either one of the operation in step S1701 and the operation in step S1702.

Next, the search range information acquiring process in step S1704 will be described with reference to the flowchart in FIG. 18.

(Step S1801) The search range information acquiring unit 14172 substitutes 1 for the counter i.

(Step S1802) The search range information acquiring unit 14172 judges whether or not the ith search range management information is present in the search range management information storage unit 14171. If the ith search range management information is present, the procedure proceeds to step S1803. If the ith search range management information is not present, the procedure returns to the upper-level function.

(Step S1803) The search range information acquiring unit 14172 reads the ith search range management information from the search range management information storage unit 14171.

(Step S1804) The search range information acquiring unit 14172 substitutes 1 for the counter j.

(Step S1805) The search range information acquiring unit 14172 judges whether or not the jth operation information is present in the operation information sequence buffer. If the jth operation information is present, the procedure proceeds to step S1806. If the jth operation information is not present, the procedure proceeds to step S1811.

(Step S1806) The search range information acquiring unit 14172 reads the jth operation information from the operation information sequence buffer.

(Step S1807) The search range information acquiring unit 14172 judges whether or not an operation information sequence constituted by operation information up to the jth operation information matches the operation sequence pattern indicated in the ith search range management information.

(Step S1808) If it is judged by the search range information acquiring unit 14172 that the operation information sequence constituted by operation information up to the jth operation information matches the operation sequence pattern, the procedure proceeds to step S1809. If it is judged that the operation information sequence does not match the operation sequence pattern, the procedure proceeds to step S1810.

(Step S1809) The search range information acquiring unit 14172 increments the counter j by 1. The procedure returns to step S1805.

(Step S1810) The search range information acquiring unit 14172 increments the counter i by 1. The procedure returns to step S1702.

(Step S1811) The search range information acquiring unit 14172 acquires the ith search range management information. The procedure returns to the upper-level function.

Next, the keyword acquiring process using the search range information in step S1704 will be described with reference to the flowchart in FIG. 19.

(Step S1901) The keyword acquiring unit 14173 judges whether or not the search range information is information for a refinement search operation information sequence (whether or not it is a refinement search). If the condition is satisfied, the procedure proceeds to step S1902. If the condition is not satisfied, the procedure proceeds to step S1910.

(Step S1902) The keyword acquiring unit 14173 judges whether or not the operation information sequence within the buffer is an operation information sequence indicating that a centering operation [c] has been performed after a zoom-in operation [i]. If this condition is matched, the procedure proceeds to step S1903. If this condition is not matched, the procedure proceeds to step S1909.

(Step S1903) The keyword acquiring unit 14173 reads map information corresponding to the centering operation [c].

(Step S1904) The keyword acquiring unit 14173 acquires positional information of the center point of the map image information contained in the map information read in step S1903. The keyword acquiring unit 14173 may read the positional information of the center point stored as a pair with the operation information contained in the operation information sequence, or may calculate the positional information of the center point based on information indicating the region of the map image information (e.g., positional information at the upper left and positional information at the lower right of the map image information).

(Step S1905) The keyword acquiring unit 14173 acquires a term paired with the positional information that is closest to the positional information of the center point acquired in step S1904, as a keyword of the destination point, from the term information contained in the map information read in step S1903.

(Step S1906) The keyword acquiring unit 14173 acquires map information at the time of a recent centering operation [c] in previous operation information, from the operation information sequence within the buffer.

(Step S1907) The keyword acquiring unit 14173 acquires positional information of the center point of the map image information contained in the map information acquired in step S1906.

(Step S1908) The keyword acquiring unit 14173 acquires a term paired with the positional information that is closest to the positional information of the center point acquired in step S1907, as a keyword of the mark point, from the term information contained in the map information read in step S1906. The procedure returns to the upper-level function.

(Step S1909) The keyword acquiring unit 14173 judges whether or not the operation information sequence within the buffer is an operation information sequence indicating that a move operation [m] has been performed after a zoom-in operation [i]. If this condition is matched, the procedure proceeds to step S1903. If this condition is not matched, the procedure returns to the upper-level function.

(Step S1910) The keyword acquiring unit 14173 judges whether or not the search range information is information for a comparison search operation information sequence. If the condition is satisfied, the procedure proceeds to step S1911. If the condition is not satisfied, the procedure proceeds to step S1921.

(Step S1911) The keyword acquiring unit 14173 judges whether or not the last operation information contained in the operation information sequence within the buffer is a zoom-out operation [o]. If this condition is matched, the procedure proceeds to step S1912. If this condition is not matched, the procedure proceeds to step S1918.

(Step S1912) The keyword acquiring unit 14173 acquires map information just after the zoom-out operation [o] indicated in the last operation information, from the information within the buffer.

(Step S1913) The keyword acquiring unit 14173 acquires map information just before the zoom-out operation [o], from the information within the buffer.

(Step S1914) The keyword acquiring unit 14173 acquires information indicating a region representing a difference between a region indicated in the map information acquired in step S1912 and a region indicated in the map information acquired in step S1913.

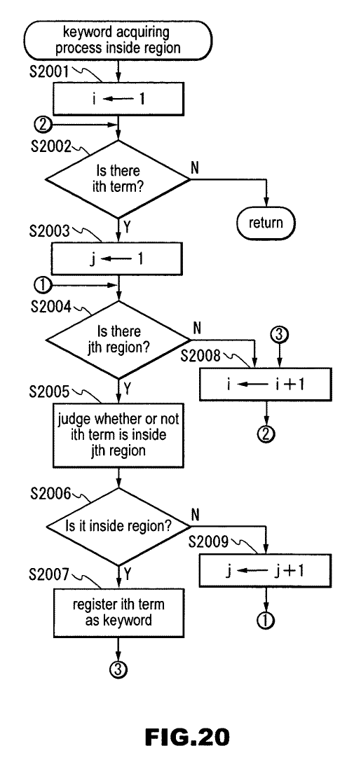

(Step S1915) The keyword acquiring unit 14173 acquires a keyword within the region identified with the information indicating the region acquired in step S1914, from the term information in the map information storage portion 1410. This keyword acquiring process inside the region will be described in detail with reference to the flowchart in FIG. 20.

(Step S1916) The keyword acquiring unit 14173 judges whether or not the number of keywords acquired in step S1915 is one. If the number of keywords is one, the procedure proceeds to step S1917. If the number of keywords is not one, the procedure returns to the upper-level function.

(Step S1917) The keyword acquiring unit 14173 extracts a keyword having the highest level of collocation with the one keyword acquired in step S1915, from the information storage apparatuses 142. Typically, the keyword acquiring unit 14173 extracts a keyword having the highest level of collocation with the one keyword acquired in step S1915, from multiple web pages stored in the one or more information storage apparatuses 142. Here, a technique for extracting a keyword having the highest level of collocation with a keyword from multiple files (e.g., web pages) is a known art, and thus a detailed description thereof has been omitted. The procedure returns to the upper-level function.

(Step S1918) The keyword acquiring unit 14173 acquires map information just after the move operation [m] indicated in the last operation information, from the information within the buffer.

(Step S1919) The keyword acquiring unit 14173 acquires map information just before the move operation [m] indicated in the last operation information, from the information within the buffer.

(Step S1920) The keyword acquiring unit 14173 acquires information indicating a region in which a keyword may be present, based on a region indicated in the map information acquired in step S1918 and a region indicated in the map information acquired in step S1919. A region of a keyword in a case where the move operation [m] functions as a trigger for a comparison search will be described later. The procedure proceeds to step S1915.

(Step S1921) The keyword acquiring unit 14173 judges whether or not the search range information is information for a route search operation information sequence. If the condition is satisfied, the procedure proceeds to step S1922. If the condition is not satisfied, the procedure returns to the upper-level function.

(Step S1922) The keyword acquiring unit 14173 acquires screen information just after the zoom-in operation [i] after the zoom-out operation [o].

(Step S1923) The keyword acquiring unit 14173 acquires positional information of the center point of the map image information contained in the screen information acquired in step S1922.

(Step S1924) The keyword acquiring unit 14173 acquires a term paired with the positional information that is closest to the positional information of the center point acquired in step S1923, as a keyword, from the term information contained in the map information read in step S1922.

(Step S1925) The keyword acquiring unit 14173 acquires a keyword of the mark point, as a keyword, in the previous refinement search that is closest to the zoom-in operation [i] after the zoom-out operation [o]. The procedure returns to the upper-level function.

It will be appreciated that, in the flowchart in FIG. 19, the process in step S1917 is not essential.

Next, the keyword acquiring process inside the region in step S1915 will be described with reference to the flowchart in FIG. 20.

(Step S2001) The keyword acquiring unit 14173 substitutes 1 for the counter i.

(Step S2002) The keyword acquiring unit 14173 judges whether or not the ith term is present in the term information contained in the corresponding map information. If the ith term is present, the procedure proceeds to step S2003. If the ith term is not present, the procedure returns to the upper-level function.

(Step S2003) The keyword acquiring unit 14173 substitutes 1 for the counter j.

(Step S2004) The keyword acquiring unit 14173 judges whether or not the jth region is present. If the jth region is present, the procedure proceeds to step S2005. If the jth region is not present, the procedure proceeds to step S2008. Here, each region is typically a rectangular region.

(Step S2005) The keyword acquiring unit 14173 judges whether or not the ith term is a term that is present inside the jth region. Here, for example, the keyword acquiring unit 14173 reads positional information (e.g., (aᵢ, bᵢ)) paired with the ith term, and judges whether or not this positional information represents a point within the region represented as the jth region ((aₓ, bₓ), (a_{y}, b_{y})) (where (aₓ, bₓ) refers to a point at the upper left in the rectangle, and (a_{y}, b_{y}) refers to a point at the lower right in the rectangle). That is to say, if the conditions ‘aₓ<=aᵢ<=a_{y}’ and ‘bₓ<=bᵢ<=b_{y}’ are satisfied, the keyword acquiring unit 14173 judges that the ith term is present inside the jth region. If the conditions are not satisfied, it is judged that the ith term is present outside the jth region.

(Step S2006) If it is judged by the keyword acquiring unit 14173 that the ith term is present inside the jth region, the procedure proceeds to step S2007. If it is judged that the ith term is not present inside the jth region, the procedure proceeds to step S2009.

(Step S2007) The keyword acquiring unit 14173 registers the ith term as a keyword. Here, the register refers to an operation to store data in a given memory. The procedure proceeds to step S2008.

(Step S2008) The keyword acquiring unit 14173 increments the counter i by 1. The procedure returns to step S2002.

(Step S2009) The keyword acquiring unit 14173 increments the counter j by 1. The procedure returns to step S2004.

Next, an example of the search process in step S1613 will be described in detail with reference to the flowchart in FIG. 21.

(Step S2101) The retrieving portion 1418 judges whether or not the search range information is information for a refinement search operation information sequence (whether or not it is a refinement search). If the condition is satisfied, the procedure proceeds to step S2102. If the condition is not satisfied, the procedure proceeds to step S2108.

(Step S2102) The retrieving portion 1418 substitutes 1 for the counter i.

(Step S2103) The retrieving portion 1418 searches the one or more information storage apparatuses 142, and judges whether or not the ith information (e.g., web page) is present. If the ith information is present, the procedure proceeds to step S2104. If the ith information is not present, the procedure returns to the upper-level function.

(Step S2104) The retrieving portion 1418 acquires the keyword of the destination point and the keyword of the mark point present in the memory, and judges whether or not the ith information contains the keyword of the destination point in its title (e.g., within the <title> tag) and the keyword of the mark point and the keyword acquired by the first keyword acquiring portion 1416 in its body (e.g., within the <body> tag). The retrieving portion 1418 may judge whether or not the information contains the keyword acquired by the first keyword acquiring portion 1416 in any portion of the information, the keyword of the destination point in its title (e.g., within the <title> tag), and the keyword of the mark point in its body (e.g., within the <body> tag).

(Step S2105) If it is judged by the retrieving portion 1418 in step S2104 that the condition is matched, the procedure proceeds to step S2106. If it is judged that the condition is not matched, the procedure proceeds to step S2107.

(Step S2106) The retrieving portion 1418 registers the ith information as information that is to be output.

(Step S2107) The retrieving portion 1418 increments the counter i by 1. The procedure returns to step S2103.

(Step S2108) The retrieving portion 1418 judges whether or not the search range information is information for a comparison search operation information sequence. If the condition is satisfied, the procedure proceeds to step S2109. If the condition is not satisfied, the procedure proceeds to step S2117.

(Step S2109) The retrieving portion 1418 substitutes 1 for the counter 1.

(Step S2110) The retrieving portion 1418 searches the one or more information storage apparatuses 142, and judges whether or not the ith information (e.g., web page) is present. If the ith information is present, the procedure proceeds to step S2111. If the ith information is not present, the procedure proceeds to step S2116.

(Step S2111) The retrieving portion 1418 acquires two keywords present in the memory, and judges whether or not the ith information contains the keyword of the destination point or the keyword of the mark point in its title (e.g., within the <title> tag) and another keyword in its body (e.g., within the <body> tag). Another keyword also includes the keyword acquired by the first keyword acquiring portion 1416.

(Step S2112) If it is judged by the retrieving portion 1418 in step S2110 that the condition is matched, the procedure proceeds to step S2113. If it is judged that the condition is not matched, the procedure proceeds to step S2115.

(Step S2113) The retrieving portion 1418 acquires the MBR of the ith information. The MBR (minimum bounding rectangle) refers to information indicating a region of interest in the ith information, and obtained by retrieving two or more terms contained in the term information from the ith information (e.g., web page) using two or more pieces of positional information of the two or more terms that have been retrieved. The MBR is, for example, a rectangular region constituted by two pieces of positional information furthest from each other, among two or more pieces of positional information corresponding to the two or more terms that have been retrieved. In this case, the MBR is information of a rectangular region identified with two points (e.g., positional information at the upper left and positional information at the lower right). The MBR is a known art. In acquisition of the MBR, the retrieving portion 1418 typically ignores a term that does not have the positional information, in the two or more terms.

(Step S2114) The retrieving portion 1418 registers the ith information and the MBR (e.g., positional information of the two points).

(Step S2115) The retrieving portion 1418 increments the counter i by 1. The procedure returns to step S2110.

(Step S2116) The retrieving portion 1418 reads pairs of the information and the MBR that have been registered (that are present in the memory), acquires information with the smallest MBR, and registers the information as information that is to be output. Here, a technique in which, if the MBR is a rectangular region designated with positional information of two points, the sizes of the areas of the rectangular regions are compared, and information (e.g., web page) paired with the MBR with the smallest area is acquired is a known art, and thus a detailed description thereof has been omitted.

(Step S2117) The retrieving portion 1418 judges whether or not the search range information is information for a route search operation information sequence. If the condition is satisfied, the procedure proceeds to step S2118. If the condition is not satisfied, the procedure returns to the upper-level function.

(Step S2118) The retrieving portion 1418 substitutes 1 for the counter i.

(Step S2119) The retrieving portion 1418 searches the one or more information storage apparatuses 142, and judges whether or not the ith information (e.g., web page) is present. If the ith information is present, the procedure proceeds to step S2120. If the ith information is not present, the procedure proceeds to step S2123.

(Step S2120) The retrieving portion 1418 acquires the MBR of the ith information.

(Step S2121) The retrieving portion 1418 registers the ith information and the MBR (e.g., positional information of the two points).

(Step S2122) The retrieving portion 1418 increments the counter i by 1. The procedure returns to step S2119.

(Step S2123) The retrieving portion 1418 acquires screen information just after the zoom-in operation [i] just after the zoom-out operation [o] in the operation information sequence buffer.

(Step S2124) The retrieving portion 1418 acquires positional information of the center point of the map indicated in the map image information contained in the screen information acquired in step S2123.

(Step S2125) The retrieving portion 1418 acquires positional information of the center point of the map indicated in the map image information contained in the screen information in the latest route search.

(Step S2126) The retrieving portion 1418 acquires information having the MBR that is closest to the MBR constituted by the positional information of the point acquired in step S2124 and the positional information of the point acquired in step S2125, and registers the information as information that is to be output. In this case, the retrieving portion 1418 searches a group of pairs of the MBR and the information registered in step S2121, and acquires information having the MBR that is closest to the MBR constituted by the positional information of the point acquired in step S2124 and the positional information of the point acquired in step S2125.

In the description above, an example of the search process was described in detail with reference to the flowchart in FIG. 21. However, as the search process, only a process of passing a keyword to a so-called web search engine and operating the search engine may be performed.

Furthermore, the retrieving portion 1418 may perform a process of constructing an SQL sentence based on the keywords acquired by the keyword acquiring unit 14173, and searching the database using the SQL sentence. Here, there is no limitation on the method for combining keywords (AND, OR usage method) in the construction of an SQL sentence.

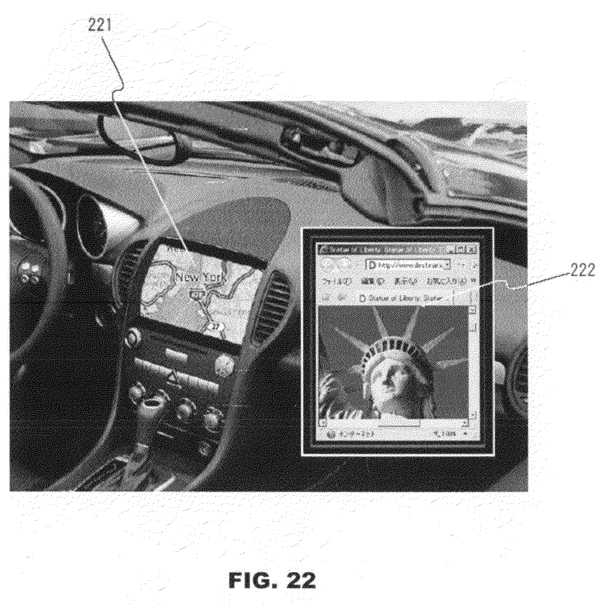

Hereinafter, a specific operation of the map information processing apparatus 141 in this embodiment will be described. FIG. 14 is a conceptual diagram of the map information processing system that has the map information processing apparatus 141. In this example, if the user performs operations on the map, or if the vehicle travels, the map information processing apparatus 141 can automatically acquire web information matching a purpose of the operations on the map and/or the travel of the vehicle, without requiring the user to be conscious of search. Furthermore, in this specific example, a meaningful operation sequence of map operations is referred to as a chunk. It is assumed that the map information processing apparatus 141 is installed on, for example, a car navigation system. For example, FIG. 22 shows a schematic view of the map information processing apparatus 141. In FIG. 22, a first display portion 221 is disposed between the driver's seat and the assistant driver's seat of the vehicle, and a second display portion 222 is disposed in front of the assistant driver's seat. Furthermore, one or more third display portions (not shown) are arranged at positions that can be viewed only from the rear seats (e.g., the back side of the driver's seat or the assistant driver's seat). A map is displayed on the first display portion 221. A web page is displayed on the second display portion 222.

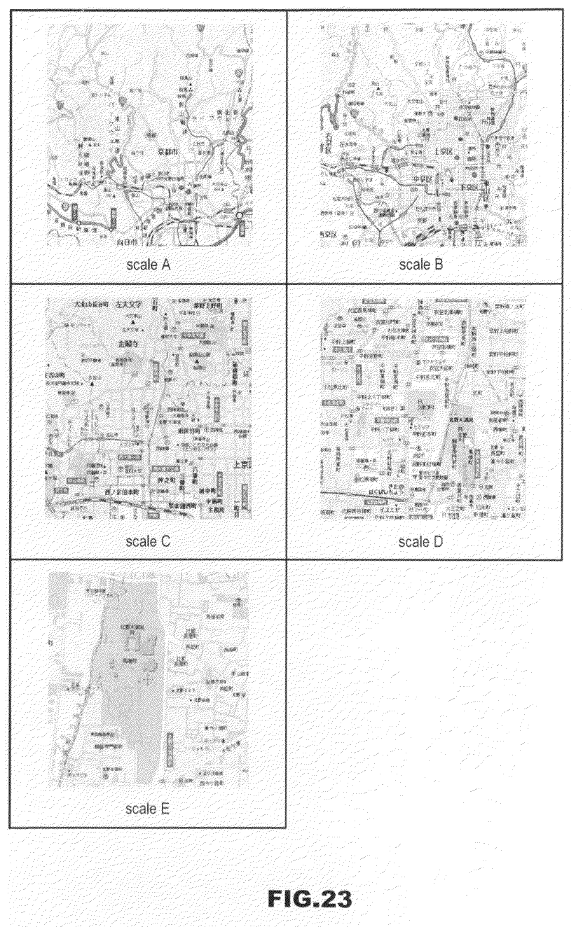

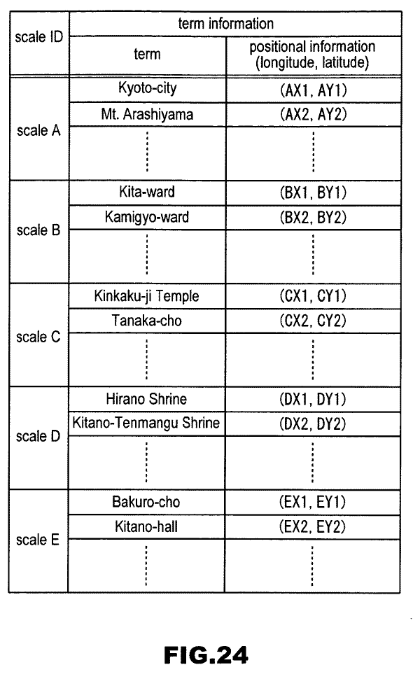

Furthermore, in the map information storage portion 1410, the map image information shown in FIG. 23 is held. The map image information is stored as a pair with information (scale A, scale B, etc.) identifying the scale of the map. Furthermore, in the map information storage portion 1410, the term information shown in FIG. 24 is held. That is to say, in the map information storage portion 1410, map image information for each different scale and term information for each different scale are stored.

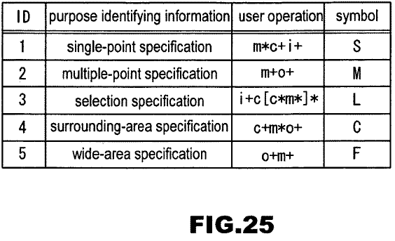

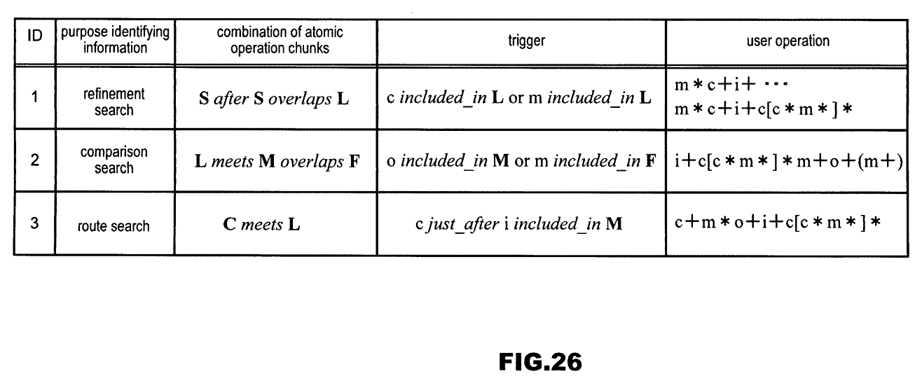

In the search range management information storage unit 14171, the atomic operation chunk management table shown in FIG. 25 and the complex operation chunk management table shown in FIG. 26 are stored. The atomic operation chunk is the smallest unit of an operation sequence for obtaining a purpose of the user. The atomic operation chunk management table has the attributes ‘ID’, ‘purpose identifying information’, ‘user operation’, and ‘symbol’. The ‘ID’ is information identifying records, and is for record management in the table. The ‘purpose identifying information’ is information identifying five types of atomic operation chunks. There are five types of atomic operation chunks, namely chunks for single-point specification, multiple-point specification, selection specification, surrounding-area specification, and wide-area specification. The single-point specification is an operation to uniquely determine and zoom in on a target, and used, for example, in order to look for accommodation at the travel destination. The multiple-point specification is an operation to zoom out from a designated target, and used, for example, in order to look for the location of a souvenir shop near the accommodation. The selection specification is an operation to perform centering of multiple points, and used, for example, in order to sequentially select tourist spots at the travel destination. The surrounding-area specification is an operation to perform a zoom-out operation to display multiple points on one screen, and used, for example, in order to check the positional relationship between the tourist spots which the user wants to visit. The wide-area specification is an operation to cause movement along multiple points, and used, for example, in order to check how far the distance is between the town where the user lives and the travel destination. The ‘user operation’ refers to an operation information sequence in a case where the user performs map browse operations. The ‘symbol’ refers to a symbol identifying an atomic operation chunk.

Furthermore, in the map information processing apparatus 141 in this example, retrieval of information containing a purpose of the user is realized by identifying a complex operation chunk in which atomic operation chunks are connected. The complex operation chunk management table is a management table for realizing this retrieval. The complex operation chunk management table has the attributes ‘ID’, ‘purpose identifying information’, ‘combination of atomic operation chunks’, ‘trigger’, and ‘user operation’. The ‘ID’ is information identifying records, and is for record management in the table. The ‘purpose identifying information’ is information identifying three types of complex operation chunks. The ‘combination of atomic operation chunks’ is information of methods for combining atomic operation chunks. In this example, there are three types of methods for connecting atomic operation chunks. The ‘overlaps’ refers to a connection method in which operations at the connecting portion are the same. The ‘meets’ refers to a connection method in which operations at the connecting portion are different from each other. The ‘after’ refers to a connection method indicating that another operation may be interposed between operations. The ‘trigger’ refers to a trigger to find a keyword. Here, ‘a include_in B’ refers to an operation a contained in a chunk B. Furthermore, ‘a just_after b’ refers to the operation a performed just after an operation b. That is to say, ‘a just_after b’ indicates that the operation a performed just after the operation b functions as a trigger. Furthermore, ‘user operation’ refers to an operation information sequence in a case where the user performs map browse operations. Here, for example, the operation information sequence stored in the search range management information storage unit 14171 is the ‘user operation’ in FIG. 26, and the search range information is the ‘purpose identifying information’ in FIG. 26. For example, the keyword acquiring unit 14173 of the map information processing apparatus 141 executes a function corresponding to the value of ‘purpose identifying information’ and acquires a keyword.

There are three types of complex operation chunk search, namely a refinement search, a comparison search, and a route search. The refinement search is the most basic search in which one given point is determined, and this point is taken as the search target. The comparison search is search in which the relationship between given points is judged, and used, for example, in a case where search is performed for the positional relationship between the accommodation at the travel destination and the nearest station. The route search is search performed by the user along the route, and used, for example, in a case where search is performed for what are on the path from the nearest station to the accommodation, and how to reach the destination.

Furthermore, it is assumed that a large number of web pages are stored in the one or more information storage apparatuses 142 constituting the map information processing system 2.

It is assumed that, in this status, the user inputs the keywords ‘Kyoto’ and ‘cherry blossom’ to the map information processing apparatus 141, and inputs a first information output instruction containing ‘Kyoto’ and ‘cherry blossom’.

It is assumed that, next, the first information output portion 1412 acquires and outputs first information (herein, a web page), using ‘Kyoto’ and ‘cherry blossom’ as keywords.

It is assumed that, then, the first information output portion 1412 stores the keywords ‘Kyoto’ and ‘cherry blossom’ (referred to as a ‘first keyword’) in a predetermined buffer.

In this status, a second keyword used for information retrieval is acquired from a map browse operation sequence that contains multiple operations to browse a map and events generated by the travel of a vehicle. That is to say, it is preferable that the map browse operation sequence is an operation sequence in which user operations and events generated by the travel of a vehicle are combined.

Then, the map information processing apparatus 141 searches for a web page using the first keyword and the second keyword. Example of this specific operation will be described below.

### SPECIFIC EXAMPLE 1

In Specific Example 1, information retrieval and output in the case of a refinement search will be described. In a refinement search, the user performs a zoom-in operation to determine a search point. Thus, a trigger to acquire a keyword is, for example, a zoom-in operation [i]. Furthermore, in a refinement search, for example, a move operation [m] or a centering operation [c] after the zoom-in operation may function as a trigger to acquire a keyword. Regarding the move operation [m] or the centering operation [c], if the vehicle travels to or is stopped at a point contained in the map information, it is judged that the move operation [m] or the centering operation [c] to that point is generated, and the map information processing apparatus 141 acquires operation information corresponding to the move operation [m] or the centering operation [c].

First, a process of obtaining a purpose of the user operations (also including a purpose of the travel of a vehicle) based on a map browse operation sequence, which is a process leading to keyword acquisition, will be described. The map browse operation includes zooming operations (a zoom-in operation [i] and a zoom-out operation [o]) and move operations (a move operation [m] and a centering operation [c]). An operation sequence that is fixed to some extent can be detected in a case where the user performs map operations with a purpose. For example, in a case where the user considers traveling to Okinawa, and tries to display Shuri Castle on a map, first, the user moves the on-screen map so that Okinawa is positioned at the center of the screen, and then displays Shuri Castle with a zoom-in operation or a move operation. Furthermore, it seems that in order to look for the nearest station to Shuri Castle on the on-screen map, the user performs a zoom-out operation from Shuri Castle to look for the nearest station, and displays the found station and Shuri Castle on one screen.

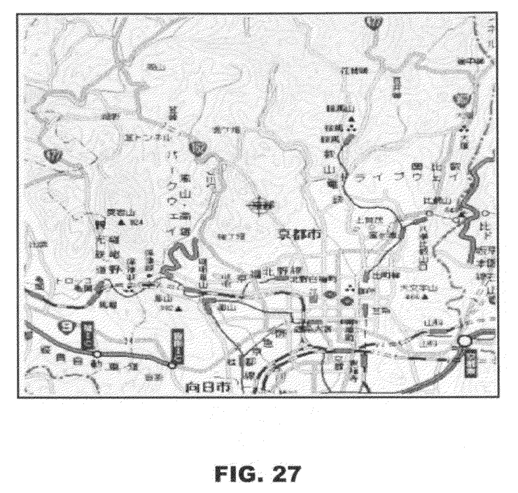

When the user starts the engine of the vehicle, the map information processing apparatus 141 is also started. Then, the accepting portion 1411 accepts a map output instruction. The map output portion 1413 reads map information from the map information storage portion 1410, and performs output on the first display portion 221, for example, as shown in FIG. 27. FIG. 27 is a map of Kyoto Prefecture. It is assumed that there are a ‘zoom-in’ button, a ‘zoom-out’ button, and upper, lower, left, and right arrow buttons (not shown) in the navigation system. It is assumed that if the ‘zoom-in’ button is pressed down, operation information [i] is generated, if the ‘zoom-out’ button is pressed down, operation information [o] is generated, if the upper, lower, left, or right arrow button is pressed down, operation information [m] is generated, and if a given position in the map information is pressed down, operation information [c] to perform centering to the pressed position is generated.

It is assumed that, during the travel of the vehicle, the user (a person in the assistant driver's seat) successively performs map operations, that is, presses down the ‘zoom-in’ button, performs the ‘centering’ operation, presses down the ‘zoom-in’ button, and then presses down the ‘zoom-in’ button.

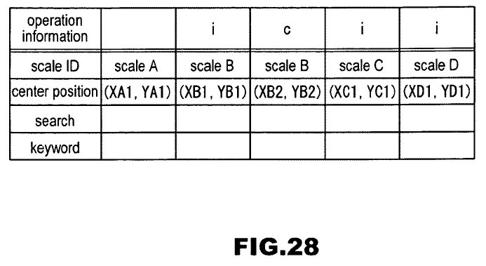

In a case where the user performs this sort of map operations, the operation information sequence acquiring portion 1415 acquires operation information corresponding to the accepted map browse operations, and temporarily stores the information in the buffer. Furthermore, the map output changing portion 1414 changes the output of the map according to the map browse operations. Then, the map output changing portion 1414 acquires map information after the change (e.g., information identifying the scale of the output map, and positional information of the center point of the output map), and stores the map information in the buffer. Then, the buffer as shown in FIG. 28 is obtained. In the buffer, ‘operation information’, ‘map information’, ‘center position’, ‘search’, and ‘keyword’ are stored in association with each other. The ‘search’ refers to a purpose of the user described above, and any one of ‘refinement search’ ‘comparison search’ and ‘route search’ may be entered as the ‘search’. As the ‘keyword’, a keyword acquired by the keyword acquiring unit 14173 may be entered.

Next, the second keyword acquiring portion 1417 tries to acquire a keyword each time the accepting portion 1411 accepts a map operation from the user, or each time the vehicle passes through a designated point or is stopped at a designated point. However, the operation information sequence does not match a trigger to acquire a keyword, and thus a keyword has not been acquired yet.

It is assumed that the user then further performs a centering operation [c]. Next, the map output changing portion 1414 changes output of the map according to this map browse operation. Then, the map output changing portion 1414 acquires map information after the change (e.g., information identifying the scale of the output map, and positional information of the center point of the output map), and stores the map information in the buffer. Next, the operation information sequence acquiring portion 1415 obtains the operation information sequence [iciic].

Next, the keyword acquiring unit 14173 searches the table in FIG. 26 based on the operation information sequence [iciic], and judges that the operation information sequence matches ‘refinement search’. That is to say, here, the operation information sequence matches the trigger to acquire a keyword. Then, the keyword acquiring unit 14173 acquires the scale ID ‘scale D’ and the information of the center position (XD2, YD2) corresponding to the last [c].

The keyword acquiring unit 14173 acquires the information of the center position (XD2, YD2). It is assumed that the keyword acquiring unit 14173 then searches for term information corresponding to the scale ID ‘scale D’, and acquires the term ‘Kitano-Tenmangu Shrine’ that is closest to the positional information (XD2, YD2).

Next, the keyword acquiring unit 14173 acquires the scale ID ‘scale B’ and the center position (XB2, YB2) at the time of a recent centering operation [c] in previous operation information, from the operation information sequence within the buffer.

Next, the keyword acquiring unit 14173 searches for term information corresponding to ‘scale B’, and acquires the term ‘Kamigyo-ward’ that is closest to the positional information (XB2, YB2).

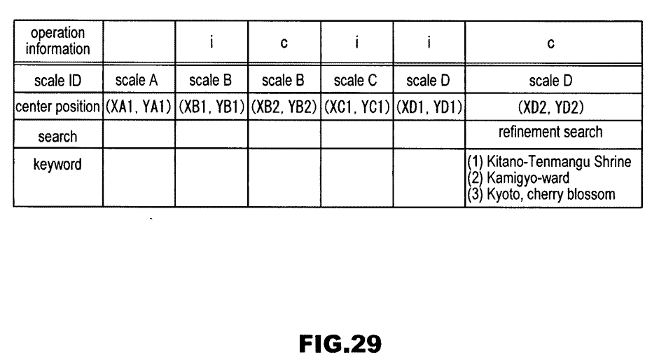

With the above-described process, the keyword acquiring unit 14173 has acquired the second keywords ‘Kitano-Tenmangu Shrine’ and ‘Kamigyo-ward’. Here, in the second keywords, the keyword ‘Kitano-Tenmangu Shrine’ is a keyword of the destination point, and ‘Kamigyo-ward’ is a keyword of the mark point. The keyword acquiring unit 14173 writes the search ‘refinement search’ and the keywords ‘Kitano-Tenmangu Shrine’ and ‘Kamigyo-ward’ to the buffer. FIG. 29 shows the data within this buffer. Furthermore, in FIG. 29, the numeral (1) in the keyword ‘(1) Kitano-Tenmangu Shrine’ indicates that this keyword is a keyword of the destination point, and the numeral (2) in the keyword ‘(2) Kamigyo-ward’ indicates that this keyword is a keyword of the mark point. In FIG. 29, the keywords ‘(3) Kyoto, cherry blossom’ indicates that these keywords are first keywords.

Next, a process of searching for a web page using the first keywords ‘Kyoto’ and ‘cherry blossom’ and the second keywords ‘Kitano-Tenmangu Shrine’ and ‘Kamigyo-ward’ will be described. The retrieving portion 1418 judges that the search range information has a refinement search operation information sequence (it is a refinement search), and acquires a website of ‘Kitano-Tenmangu Shrine’, which is a web page that contains ‘Kitano-Tenmangu Shrine’ in its title (within the <title> tag) and ‘Kyoto’, ‘cherry blossom’, and ‘Kamigyo-ward’ in its body (within the <body> tag). However, the vehicle is currently traveling. Accordingly, the second information output portion 1419 receives a signal indicating that the vehicle is traveling, and does not output the website of ‘Kitano-Tenmangu Shrine’ to the second display portion 222 that can be viewed by the driver. Conversely, the website of ‘Kitano-Tenmangu Shrine’ is output to the one or more third display portions that can be viewed from the rear seats.

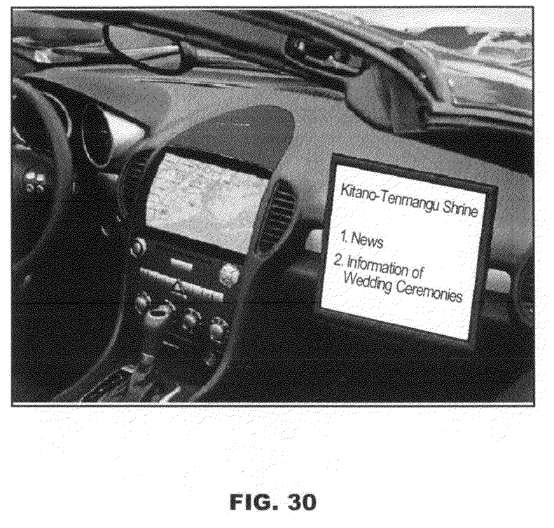

If the vehicle is stopped, the second information output portion 1419 detects the vehicle stopping (also including acquisition of a stopping signal from the vehicle), and outputs the website of ‘Kitano-Tenmangu Shrine’ also to the second display portion 222 (see FIG. 30).

Accordingly, more appropriate information can be presented to the user, using information obtained based on keywords input by the user and information output due to user operations. Furthermore, effects similar to those obtained in a case where a map operation is performed are achieved with the travel of a vehicle. Thus, also when the user is driving a vehicle, appropriate information can be obtained, and the safety can be secured.

### SPECIFIC EXAMPLE 2

In Specific Example 2, information retrieval and output in the case of a comparison search will be described. It seems that in a comparison search, the user performs a zoom-out operation [o] or a move operation [m] to present multiple given points on the screen. Thus, a trigger to acquire a keyword is typically a zoom-out operation [o] or a move operation [m].

It is assumed that from the state of the buffer in FIG. 29, the user successively performs a move operation [m] and a zoom-out operation [o].

Next, the operation information sequence acquiring portion 1415 acquires operation information corresponding to the accepted map browse operations, and temporarily stores the information in the buffer. Furthermore, the map output changing portion 1414 changes the output of the map according to the map browse operations. Then, the map output changing portion 1414 acquires map information after the change (e.g., information identifying the scale of the output map, and positional information of the center point of the output map), and stores the map information in the buffer.

Next, the keyword acquiring unit 14173 searches the table in FIG. 26 based on the operation information sequence [iciicmo], and judges that the operation information sequence matches ‘comparison search’. Then, the keyword acquiring unit 14173 acquires the scale ID ‘scale C’ and the information of the center position (XC2, YC2) corresponding to the last [o].

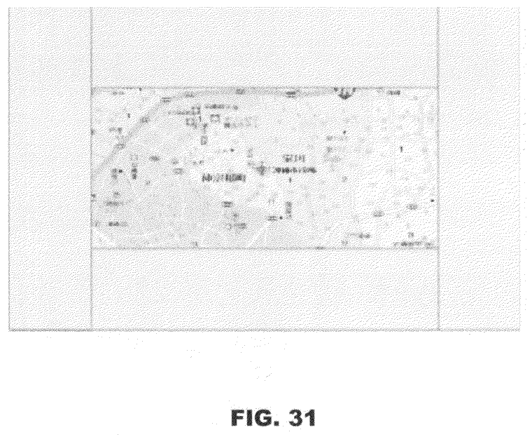

Next, the keyword acquiring unit 14173 acquires the scale ID ‘scale D’ and the information of the center position (XD3, YD3) before the zoom-out operation [o]. Then, the keyword acquiring unit 14173 acquires information indicating a region [R(o)] representing a difference between a region [Oₗₐₛₜ] indicated in the map information (‘scale C’, (XC2, YC2)) and a region [Oₗₐₛₜ₋₁] indicated in the map information (‘scale D’, (XD3, YD3)). FIG. 31 shows a conceptual diagram thereof In FIG. 31, the shaded portion indicating the region representing the difference between the region after the zoom-out and the region before the zoom-out is the region [R(o)] in which a keyword may be present. That is to say, ‘[R(o)]=[Oₗₐₛₜ]−[Oₗₐₛₜ₋₁]’.

Next, the keyword acquiring unit 14173 judges whether or not, among points designated by the positional information contained in the term information in the map information storage portion 1410, there is a point contained within the region [R(o)]. The keyword acquiring unit 14173 acquires a term corresponding to the positional information of that point, as a keyword. It is assumed that the keyword acquiring unit 14173 has acquired the keyword ‘Kinkaku-ji Temple’.

Next, the keyword acquiring unit 14173 acquires the previously acquired keyword ‘Kitano-Tenmangu Shrine’ of the destination point.

As described above, the keyword acquiring unit 14173 has acquired the keywords ‘Kinkaku-ji Temple’ and ‘Kitano-Tenmangu Shrine’ in the comparison search.

Next, the retrieving portion 1418 retrieves a web page that contains the first keywords ‘Kyoto’ and ‘cherry blossom’ and the second keywords ‘Kinkaku-ji Temple’ and ‘Kitano-Tenmangu Shrine’ and has the smallest MBR, from the information storage apparatuses 142. Then, the second information output portion 1419 outputs the web page retrieved by the retrieving portion 1418. Herein, the retrieving portion 1418 may acquire a web page having the smallest MBR, using the first keyword ‘cherry blossom’ that does not have the positional information as an ordinary search keyword, from web pages that contain ‘cherry blossom’. There is no limitation on how the retrieving portion 1418 uses the keywords.

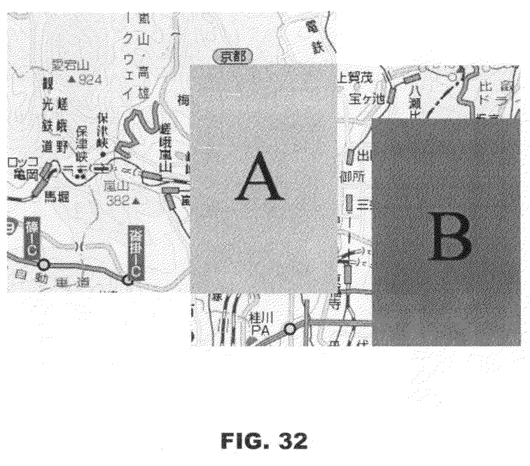

Here, in the comparison search, in a case where the last operation information is a move operation [m], if the map information after the last move operation is taken as (mₗₐₛₜ) and the map information before the move operation is taken as (mₗₐₛₜ₋₁), a map range (R(m)) in which at least one keyword is contained is ‘R(m)=mₗₐₛₜ−(mₗₐₛₜ∩mₗₐₛₜ₋₁)’. Furthermore, since the user will want to display comparison targets as large as possible, keywords for the comparison targets seem to be present in the region ‘R(m0)=R(m)∪R(m′)’. Here, R(m′) refers to a range obtained by turning R(m) about the center of the map. This map range is shown in the drawing as {shaded portion A∪ shaded portion B} in FIG. 32. These map ranges are ranges in which keywords are present. FIG. 32 shows that the output map has moved from the left large rectangle to the right large rectangle. The region of R(m) is ‘A’ in FIG. 32, and the region of R(m′) is ‘B’ in FIG. 32. The region (R(m0)) in which a second keyword may be present is the region ‘A’ or ‘B’.

### SPECIFIC EXAMPLE 3

In Specific Example 3, information retrieval and output in the case of a route search will be described. It seems that in a route search, the user performs a zoom-in operation [i] while confirming an outline of the route with a zoom-out operation [o], and causes movement along the route that the user follows while performing a centering operation [c]. Thus, the centering operation [c] after the confirmation operation (the zoom-in operation [i] after the zoom-out operation [o] is the confirmation operation) typically functions as a trigger to acquire a keyword.

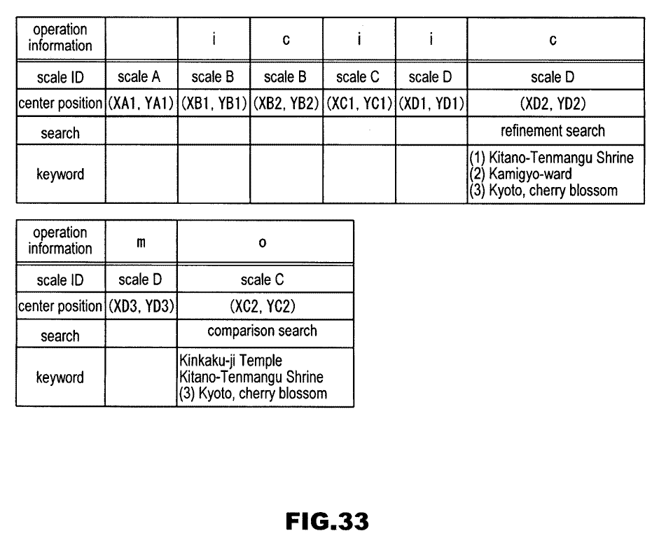

It is assumed that from the state of the buffer in FIG. 33, the user successively performs a centering operation [c], a zoom-out operation [o], a zoom-in operation [i], and a centering operation [c].

Next, the operation information sequence acquiring portion 1415 acquires operation information corresponding to the accepted map browse operations, and temporarily stores the information in the buffer. Furthermore, the map output changing portion 1414 changes the output of the map according to the map browse operations. Then, the map output changing portion 1414 acquires map information after the change (e.g., information identifying the scale of the output map, and positional information of the center point of the output map), and stores the map information in the buffer.

Next, the keyword acquiring unit 14173 searches the table in FIG. 26 based on the operation information sequence [iciicmocoic] and judges that the operation information sequence matches ‘route search’. Then, the keyword acquiring unit 14173 acquires the scale ID ‘scale C’ and the information of the center position (XC5, YC5) corresponding to the last [c].

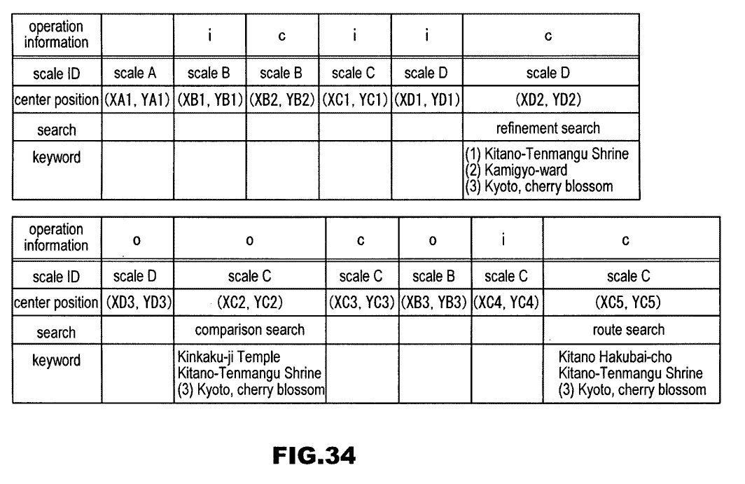

Next, the keyword acquiring unit 14173 acquires, as a keyword, the term ‘Kitano Hakubai-cho’ paired with the positional information that is closest to the information of the center position (XC5, YC5), among points designated by the positional information contained in the term information corresponding to the scale ID ‘scale C’, in the map information storage portion 1410. Next, the keyword acquiring unit 14173 also acquires the keyword ‘Kitano-Tenmangu Shrine’ of the destination point in the latest refinement search. With the above-described process, the buffer content in FIG. 34 is obtained.

As described above, the keyword acquiring unit 14173 has acquired the second keywords ‘Kitano Hakubai-cho’ and ‘Kitano-Tenmangu Shrine’ in the route search.

Next, the retrieving portion 1418 acquires each piece of information in the information storage apparatuses 142, and calculates the MBR of each piece of information that has been acquired.

Next, the retrieving portion 1418 calculates the MBR of the keywords based on the first keywords ‘Kyoto’ and ‘cherry blossom’ and the second keywords ‘Kitano Hakubai-cho’ and ‘Kitano-Tenmangu Shrine’, and determines information having the MBR that is closest to this MBR of the keywords, as information that is to be output. Herein, the retrieving portion 1418 may acquire a web page having the smallest MBR, using the first keyword ‘cherry blossom’ that does not have the positional information as an ordinary search keyword, from web pages that contain ‘cherry blossom’. There is no limitation on how the retrieving portion 1418 uses the keywords.

Then, the second information output portion 1419 outputs the information (web page) acquired by the retrieving portion 1418.

As described above, according to this embodiment, it is possible to provide appropriate additional information, by automatically detecting an operation sequence performed by the user on a map, information of a point through which the vehicle passes or at which the vehicle is stopped in the travel of the vehicle, and the like.

Furthermore, according to this embodiment, it is possible to acquire keywords timely and effectively and to obtain information that the user desires, by specifically prescribing atomic operation chunks and complex operation chunks as the operation information sequences, and acquiring keywords if an operation information sequence matches a designated complex operation chunk.

Moreover, according to this embodiment, a navigation system including the map information processing apparatus can be constituted. With this navigation system, for example, desired information (web page, etc.) can be automatically obtained when driving, and thus driving can be significantly assisted.

In this embodiment, as specific examples of the operation information sequence, the single-point specifying operation information sequence, the multiple-point specifying operation information sequence, the selection specifying operation information sequence, the surrounding-area specifying operation information sequence, and the wide-area specifying operation information sequence, and the combinations of the five types of operation information sequences (the refinement search operation information sequence, the comparison search operation information sequence, and the route search operation information sequence) were shown. Furthermore, in this embodiment, examples of the trigger to acquire a keyword for each operation information sequence was clearly shown. However, the operation information sequence in a case where a keyword is acquired or the trigger to acquire a keyword is not limited to those described above.

Furthermore, in this embodiment, the map information processing apparatus may be an apparatus that simply processes a map browse operation sequence and retrieves information, and another apparatus may display the map or change display of the map. The map information processing apparatus in this case is a map information processing apparatus, comprising: a map information storage portion in which map information, which is information of a map, can be stored; an accepting portion that accepts a first information output instruction, which is an instruction to output first information, and a map browse operation sequence, which is multiple operations to browse the map; a first information output portion that outputs first information according to the first information output instruction; an operation information sequence acquiring portion that acquires an operation information sequence, which is information of multiple operations corresponding to the map browse operation sequence; a first keyword acquiring portion that acquires a keyword contained in the first information output instruction or a keyword corresponding to the first information; a second keyword acquiring portion that acquires at least one keyword from the map information, using the operation information sequence; a retrieving portion that retrieves information using at least two keywords acquired by the first keyword acquiring portion and the second keyword acquiring portion; and a second information output portion that outputs the information retrieved by the retrieving portion. Furthermore, in this map information processing apparatus, the map of the map information storage portion may be present in an external apparatus, and the map information processing apparatus may perform a process of acquiring the map information from the external apparatus.

The software that realizes the map information processing apparatus in this embodiment may be a following program. Specifically, this program is a program for causing a computer to function as: an accepting portion that accepts a first information output instruction, which is an instruction to output first information, and a map browse operation sequence, which is multiple operations to browse the map; a first information output portion that outputs first information according to the first information output instruction; an operation information sequence acquiring portion that acquires an operation information sequence, which is information of multiple operations corresponding to the map browse operation sequence; a first keyword acquiring portion that acquires a keyword contained in the first information output instruction or a keyword corresponding to the first information; a second keyword acquiring portion that acquires at least one keyword from map information stored in a storage medium, using the operation information sequence; a retrieving portion that retrieves information using at least two keywords acquired by the first keyword acquiring portion and the second keyword acquiring portion; and a second information output portion that outputs the information retrieved by the retrieving portion.

Furthermore, in this program, it is preferable that the accepting portion also accepts a map output instruction to output the map, and the program causes the computer to further function as: a map output portion that reads the map information and outputs the map in a case where the accepting portion accepts the map output instruction; and a map output changing portion that changes output of the map according to a map browse operation in a case where the accepting portion accepts the map browse operation.

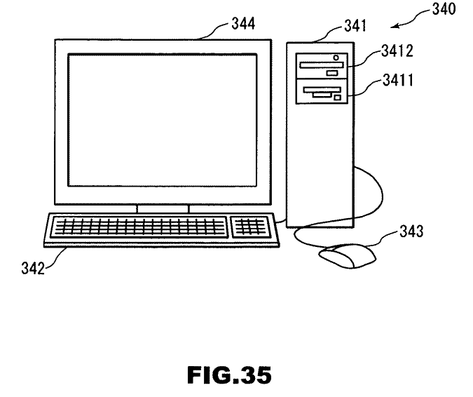

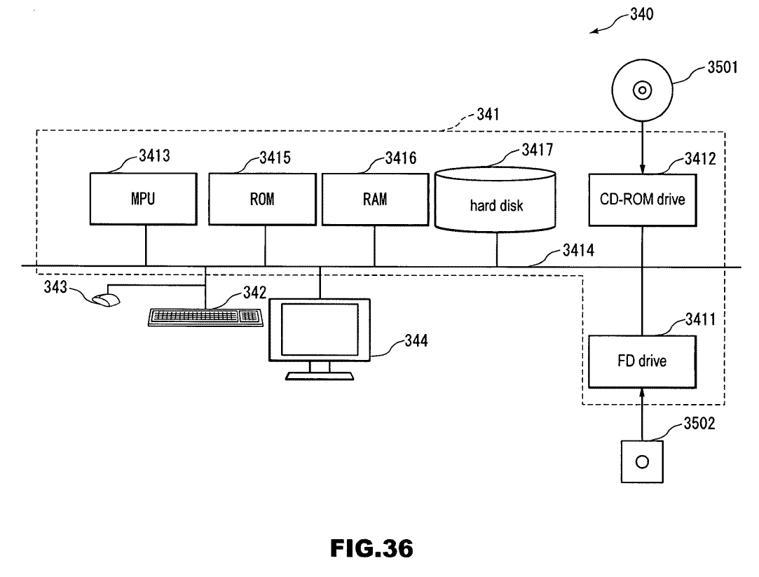

FIG. 35 shows the external appearance of a computer that executes the programs described in this specification to realize the map information processing apparatus and the like in the foregoing embodiments. The foregoing embodiments may be realized by computer hardware and a computer program executed thereon. FIG. 24 is a schematic view of a computer system 340. FIG. 35 is a schematic view of a computer system 340. FIG. 36 is a block diagram of the computer system 340.

In FIG. 35, the computer system 340 includes a computer 341 including an FD drive and a CD-ROM drive, a keyboard 342, a mouse 343, and a monitor 344.

In FIG. 36, the computer 341 includes not only the FD drive 3411 and the CD-ROM drive 3412, but also an MPU 3413, a bus 3414 that is connected to the CD-ROM drive 3412 and the FD drive 3411, a RAM 3416 that is connected to a ROM 3415 where a program such as a startup program is to be stored, and in which a command of an application program is temporarily stored and a temporary storage area is to be provided, and a temporary storage area is to be provided, and a hard disk 3417 in which an application program, a system program, and data are to be stored. Although not shown, the computer 341 may further include a network card that provides connection to a LAN.

The program for causing the computer system 340 to execute the functions of the map information processing apparatus and the like in the foregoing embodiments may be stored in a CD-ROM 3501 or an FD 3502, inserted into the CD-ROM drive 3412 or the FD drive 3411, and transmitted to the hard disk 3417. Alternatively, the program may be transmitted via a network (not shown) to the computer 341 and stored in the hard disk 3417. At the time of execution, the program is loaded into the RAM 3416. The program may be loaded from the CD-ROM 3501 or the FD 3502, or directly from a network.

The program does not necessarily have to include, for example, an operating system (OS) or a third party program for causing the computer 341 to execute the functions of the map information processing apparatus and the like in the foregoing embodiments. The program may only include a command portion to call an appropriate function (module) in a controlled mode and obtain desired results. The manner in which the computer system 340 operates is well known, and thus a detailed description thereof has been omitted.

It should be noted that in the program, in a step of transmitting information, a step of receiving information, or the like, a process that is performed by hardware, for example, a process performed by a modem, an interface card, or the like in the transmitting step (a process that can only be performed by hardware) is not included.

Furthermore, the computer that executes this program may be a single computer, or may be multiple computers. More specifically, centralized processing may be performed, or distributed processing may be performed.

Furthermore, in the foregoing embodiments, it will be appreciated that two or more communication units (a terminal information transmitting portion, a terminal information receiving portion, etc.) in one apparatus may be physically realized as one medium.

Furthermore, in the foregoing embodiments, each processing (each function) may be realized as integrated processing using a single apparatus (system), or may be realized as distributed processing using multiple apparatuses.

The present invention is not limited to the embodiments set forth herein. Various modifications are possible within the scope of the present invention.

As described above, the map information processing apparatus according to the present invention has an effect to present appropriate information, and thus this apparatus is useful, for example, as a navigation system.

What is claimed is:

1. A map information processing apparatus, comprising:
a map information storage portion in which multiple pieces of map information, which is information displayed on a map and having at least one object containing positional information on the map, can be stored;
an accepting portion that accepts a map output instruction, which is an instruction to output the map, and a map browse operation sequence, which is one or at least two operations to browse the map;
a map output portion that reads the map information and outputs the map in a case where the accepting portion accepts the map output instruction;
an operation information sequence acquiring portion that acquires an operation information sequence, which is information of one or at least two operations corresponding to the map browse operation sequence accepted by the accepting portion;
a display attribute determining portion that selects at least one object and determines a display attribute of the at least one object in a case where the operation information sequence matches an object selecting condition, which is a predetermined condition for selecting an object; and
a map output changing portion that acquires map information corresponding to the map browse operation, and outputs map information having the at least one object according to the display attribute of the at least one object determined by the display attribute determining portion.

2. The map information processing apparatus according to claim 1, further comprising a relationship information storage portion in which relationship information, which is information related to a relationship between at least two objects, can be stored,
wherein the display attribute determining portion selects at least one object and determines a display attribute of the at least one object, using the operation information sequence and the relationship information between at least two objects.

3. The map information processing apparatus according to claim 2,
wherein multiple pieces of map information of the same region with different scales are stored in the map information storage portion,
the map information processing apparatus further comprises a relationship information acquiring portion that acquires relationship information between at least two objects using an appearance pattern of the at least two objects in the multiple pieces of map information with different scales and positional information of the at least two objects, and
the relationship information stored in the relationship information storage portion is the relationship information acquired by the relationship information acquiring portion.

4. The map information processing apparatus according to claim 2, wherein the relationship information includes a same-level relationship in which at least two objects are in the same level, a higher-level relationship in which one object is in a higher level than another object, and a lower-level relationship in which one object is in a lower level than another object.

5. The map information processing apparatus according to claim 1, wherein the display attribute determining portion comprises:
an object selecting condition storage unit in which at least one object selecting condition containing an operation information sequence is stored;
a judging unit that judges whether or not the operation information sequence matches any of the at least one object selecting condition;
an object selecting unit that selects at least one object corresponding to the object selecting condition judged by the judging unit to be matched; and
a display attribute value setting unit that sets a display attribute of the at least one object selected by the object selecting unit, to a display attribute value corresponding to the object selecting condition judged by the judging unit to be matched.

6. The map information processing apparatus according to claim 1, wherein the display attribute value is an attribute value with which an object is displayed in an emphasized manner or an attribute value with which an object is displayed in a deemphasized manner.

7. The map information processing apparatus according to claim 6, wherein the display attribute determining portion sets a display attribute of at least one object that is not contained in the map information corresponding to a previously displayed map and that is contained in the map information corresponding to a newly displayed map, to an attribute value with which the at least one object is displayed in an emphasized manner.

8. The map information processing apparatus according to claim 6, wherein the display attribute determining portion sets a display attribute of at least one object that is contained in the map information corresponding to a previously displayed map and that is contained in the map information corresponding to a newly displayed map, to an attribute value with which the at least one object is displayed in a deemphasized manner.

9. The map information processing apparatus according to claim 6, wherein the display attribute determining portion selects at least one object that is contained in the map information corresponding to a newly displayed map and that satisfies a predetermined condition, and sets an attribute value of the at least one selected object to an attribute value with which the at least one object is displayed in an emphasized manner.

10. The map information processing apparatus according to claim 1,
wherein the map browse operation includes a zoom-in operation (symbol [i]), a zoom-out operation (symbol [o]), a move operation (symbol [m]), and a centering operation (symbol [c]), and
the operation information sequence includes any one of
a multiple-point search operation information sequence, which is information indicating an operation sequence of c+o+[mc]+([+] refers to repeating an operation at least once), and is an operation information sequence corresponding to an operation to widen a search range from one point to a wider region;
an interesting-point refinement operation information sequence, which is information indicating an operation sequence of c+o+([mc]*c+i+)+([*] refers to repeating an operation at least zero times), and is an operation information sequence corresponding to an operation to obtain detailed information of one point of interest;
a simple movement operation information sequence, which is information indicating an operation sequence of [mc]+, and is an operation information sequence causing movement along multiple points;
a selection movement operation information sequence, which is information indicating an operation sequence of [mc]+, and is an operation information sequence sequentially selecting multiple points; and
a position confirmation operation information sequence, which is information indicating an operation sequence of [mc]+o+i+, and is an operation information sequence checking a relative position of one point.

11. A map information processing apparatus, comprising:
a map information storage portion in which map information, which is information of a map, can be stored;
an accepting portion that accepts a first information output instruction, which is an instruction to output first information, and a map browse operation sequence, which is multiple operations to browse the map;
a first information output portion that outputs first information according to the first information output instruction;
an operation information sequence acquiring portion that acquires an operation information sequence, which is information of multiple operations corresponding to the map browse operation sequence;
a first keyword acquiring portion that acquires a keyword contained in the first information output instruction or a keyword corresponding to the first information;
a second keyword acquiring portion that acquires at least one keyword from the map information, using the operation information sequence;
a retrieving portion that retrieves information using at least two keywords acquired by the first keyword acquiring portion and the second keyword acquiring portion; and
a second information output portion that outputs the information retrieved by the retrieving portion.

12. The map information processing apparatus according to claim 11,
wherein the accepting portion also accepts a map output instruction to output the map, and
the map information processing apparatus further comprises:
a map output portion that reads the map information and outputs the map in a case where the accepting portion accepts the map output instruction; and
a map output changing portion that changes output of the map according to a map browse operation in a case where the accepting portion accepts the map browse operation.

13. The map information processing apparatus according to claim 12, wherein the second keyword acquiring portion comprises:
a search range management information storage unit in which at least two pieces of search range management information are stored, each of which is a pair of an operation information sequence and search range information, which is information of a map range of a keyword that is to be acquired;
a search range information acquiring unit that acquires search range information corresponding to the operation information sequence that is at least one piece of operation information acquired by the operation information sequence acquiring portion, from the search range management information storage unit; and
a keyword acquiring unit that acquires at least one keyword from the map information, according to the search range information acquired by the search range information acquiring unit.

14. The map information processing apparatus according to claim 13,
wherein the map browse operation includes a zoom-in operation (symbol [i]), a zoom-out operation (symbol [o]), a move operation (symbol [m]), and a centering operation (symbol [c]), and
the operation information sequence includes any one of:
a single-point specifying operation information sequence, which is information indicating an operation sequence of m*c+i+([*] refers to repeating an operation at least zero times, and [+] refers to repeating an operation at least once), and is an operation information sequence specifying one given point;
a multiple-point specifying operation information sequence, which is information indicating an operation sequence of m+o+, and is an operation information sequence specifying at least two given points;
a selection specifying operation information sequence, which is information indicating an operation sequence of i+c[c*m*]*, and is an operation information sequence sequentially selecting multiple points;
a surrounding-area specifying operation information sequence, which is information indicating an operation sequence of c+m*o+, and is an operation information sequence checking a positional relationship between multiple points;
a wide-area specifying operation information sequence, which is information indicating an operation sequence of o+m+, and is an operation information sequence causing movement along multiple points; and
a combination of at least two of the five types of operation information sequences.

15. The map information processing apparatus according to claim 14, wherein the combination of the five types of operation information sequences is any one of:
a refinement search operation information sequence, which is an operation information sequence in which a single-point specifying operation information sequence is followed by a single-point specifying operation information sequence, and then the latter single-point specifying operation information sequence is followed by and partially overlapped with a selection specifying operation information sequence;
a comparison search operation information sequence, which is an operation information sequence in which a selection specifying operation information sequence is followed by a multiple-point specifying operation information sequence, and then the multiple-point specifying operation information sequence is followed by and partially overlapped with a wide-area specifying operation information sequence; and
a route search operation information sequence, which is an operation information sequence in which a surrounding-area specifying operation information sequence is followed by a selection specifying operation information sequence.

16. The map information processing apparatus according to claim 15,
wherein in the search range management information storage unit, at least search range management information is stored that has a refinement search operation information sequence and refinement search target information as a pair, the refinement search target information being information to the effect that a keyword of a destination point is acquired that is a point near the center point of the map output in a centering operation accepted after a zoom-in operation or in a move operation accepted after a zoom-in operation, and
in a case where it is judged that the operation information sequence that is at least two pieces of operation information acquired by the operation information sequence acquiring portion corresponds to the refinement search operation information sequence, the search range information acquiring unit acquires the refinement search target information, and
the keyword acquiring unit acquires at least a keyword of a destination point corresponding to the refinement search target information acquired by the search range information acquiring unit.

17. The map information processing apparatus according to claim 16,
wherein the refinement search target information also includes information to the effect that a keyword of a mark point is acquired that is a point near the center point of the map output in a centering operation accepted before a zoom-in operation, and
the keyword acquiring unit also acquires a keyword of a mark point corresponding to the refinement search target information acquired by the search range information acquiring unit.

18. The map information processing apparatus according to claim 15,
wherein in the search range management information storage unit, at least search range management information is stored that has a comparison search operation information sequence and comparison search target information as a pair, the comparison search target information being information indicating a region representing a difference between the region of the map output after a zoom-out operation and the region of the map output before the zoom-out operation, and
in a case where it is judged that the operation information sequence that is at least two pieces of operation information acquired by the operation information sequence acquiring portion corresponds to the comparison search operation information sequence, the search range information acquiring unit acquires the comparison search target information, and
the keyword acquiring unit acquires at least a keyword corresponding to the comparison search target information acquired by the search range information acquiring unit.

19. The map information processing apparatus according to claim 15,
wherein in the search range management information storage unit, at least search range management information is stored that has a comparison search operation information sequence and comparison search target information as a pair, the comparison search target information being information indicating a region obtained by excluding the region of the map output before a move operation from the region of the map output after the move operation, and
in a case where it is judged that the operation information sequence that is at least two pieces of operation information acquired by the operation information sequence acquiring portion corresponds to the comparison search operation information sequence, the search range information acquiring unit acquires the comparison search target information, and
the keyword acquiring unit acquires at least a keyword corresponding to the comparison search target information acquired by the search range information acquiring unit.

20. The map information processing apparatus according to claim 18,
wherein the information retrieved by the retrieving portion is multiple web pages on the Internet, and
in a case where a keyword corresponding to the comparison search target information acquired by the search range information acquiring unit is acquired, and the number of keywords acquired is only one, the keyword acquiring unit searches the multiple web pages for a keyword having the highest level of collocation with the one keyword, and acquires the keyword.

21. The map information processing apparatus according to claim 15,
wherein in the search range management information storage unit, at least search range management information is stored that has a route search operation information sequence and route search target information as a pair, the route search target information being information to the effect that a keyword of a destination point is acquired that is a point near the center point of the map output in an accepted zoom-in operation or zoom-out operation, and
in a case where it is judged that the operation information sequence that is at least one piece of operation information acquired by the operation information sequence acquiring portion corresponds to the route search operation information sequence, the search range information acquiring unit acquires the route search target information, and
the keyword acquiring unit acquires at least a keyword of a destination point corresponding to the route search target information acquired by the search range information acquiring unit.

22. The map information processing apparatus according to claim 21,
wherein the route search target information also includes information to the effect that a keyword of a mark point is acquired that is a point near the center point of the map output in a centering operation accepted before a zoom-in operation, and
the keyword acquiring unit also acquires a keyword of a mark point corresponding to the route search target information acquired by the search range information acquiring unit.

23. The map information processing apparatus according to claim 11,
wherein the operation information sequence acquiring portion acquires an operation information sequence, which is a series of at least two pieces of operation information, and ends one automatically acquired operation information sequence in a case where a given condition is matched, and
the second keyword acquiring portion acquires at least one keyword from the map information using the one operation information sequence.

24. The map information processing apparatus according to claim 23, wherein the given condition is a situation in which a movement distance in a move operation is larger than a predetermined threshold value.

25. The map information processing apparatus according to claim 11, wherein the information to be retrieved by the retrieving portion is at least one web page on the Internet.

26. The map information processing apparatus according to claim 16,
wherein the information to be retrieved by the retrieving portion is at least one web page on the Internet, and
in a case where the accepting portion accepts a refinement search operation information sequence, the retrieving portion retrieves a web page that has the keyword of the destination point in a title thereof and the keyword of the mark point and the keyword acquired by the first keyword acquiring portion in a page thereof.

27. The map information processing apparatus according to claim 16,
wherein the map information has map image information indicating an image of the map, and term information having a term on the map and positional information indicating the position of the term,
the information to be retrieved by the retrieving portion is at least one web page on the Internet, and
the retrieving portion acquires at least one web page that contains all of the keyword acquired by the first keyword acquiring portion, the keyword of the mark point, and the keyword of the destination point, detects at least two terms from each of the at least one web page that has been acquired, acquires at least two pieces of positional information indicating the positions of the at least two terms, from the map information, acquires geographical range information, which is information indicating a geographical range of a description of a web page, for each web page, using the at least two pieces of positional information, and acquires at least a web page in which the geographical range information indicates the smallest geographical range.

28. The map information processing apparatus according to claim 27, wherein in a case where at least one web page that contains the keyword acquired by the first keyword acquiring portion, the keyword of the mark point, and the keyword of the destination point is acquired, the retrieving portion acquires at least one web page that has at least one of the keywords in a title thereof.

29. A navigation system, comprising the map information processing apparatus according to claim 1.

30. A navigation system, comprising the map information processing apparatus according to claim 11.

31. The navigation system according to claim 30, wherein the second information output portion does not output the information retrieved by the retrieving portion when a moving object is traveling.

32. A map information processing method, comprising:
an accepting step of accepting a map output instruction, which is an instruction to output a map, and a map browse operation sequence, which is one or at least two operations to browse the map;
a map output step of reading map information from a storage medium and outputting a map in a case where the map output instruction is accepted in the accepting step;
an operation information sequence acquiring step of acquiring an operation information sequence, which is information of one or at least two operations corresponding to the map browse operation sequence accepted in the accepting step;
a display attribute determining step of selecting at least one object and determining a display attribute of the at least one object in a case where the operation information sequence matches an object selecting condition, which is a predetermined condition for selecting an object; and
a map output changing step of acquiring map information corresponding to the map browse operation, and outputting map information having the at least one object according to the display attribute of the at least one object determined in the display attribute determining step.

33. The map information processing method according to claim 32, wherein in the display attribute determining step, at least one object is selected and a display attribute of the at least one object is determined, using the operation information sequence and relationship information between at least two objects.

34. A map information processing method, comprising:
an accepting step of accepting a first information output instruction, which is an instruction to output first information, and a map browse operation sequence, which is multiple operations to browse a map;
a first information output step of outputting first information according to the first information output instruction;
an operation information sequence acquiring step of acquiring an operation information sequence, which is information of multiple operations corresponding to the map browse operation sequence;
a first keyword acquiring step of acquiring a keyword contained in the first information output instruction or a keyword corresponding to the first information;
a second keyword acquiring step of acquiring at least one keyword from map information stored in a storage medium, using the operation information sequence;
a retrieving step of retrieving information using at least two keywords acquired in the first keyword acquiring step and the second keyword acquiring step; and
a second information output step of outputting the information retrieved in the retrieving step.

35. The map information processing method according to claim 34,
wherein in the accepting step, a map output instruction to output the map is also accepted, and
the map information processing method further comprises:
a map output step of reading the map information and outputting the map in a case where the map output instruction is accepted in the accepting step; and
a map output changing step of changing output of the map according to a map browse operation in a case where the map browse operation is accepted in the accepting step.
